(19) United States
(12) Patent Application Publication
(10) Pub. No.: US 2026/0109252 A1
(43) Pub. Date: Apr. 23, 2026

(54) CHARGING CONTROL SYSTEM FOR SECONDARY BATTERIES

(71) Applicant: Mazda Motor Corporation, Hiroshima (JP)

(72) Inventors: Chinami MORISHIMA, Aki-gun (JP); Yuma YAMAGA, Aki-gun (JP); Takafumi TANEHIRA, Aki-gun (JP); Kiyoshi OJI, Aki-gun (JP); Daiki TOKUDA, Aki-gun (JP)

(21) Appl. No.: 19/346,790

(22) Filed: Oct. 1, 2025

(30) Foreign Application Priority Data
Oct. 22, 2024 (JP) 2024-185968

(51) Int. Cl. B60L 53/62; B60L 53/10; B60L 53/20

(52) U.S. Cl. CPC B60L 53/62; B60L 53/11; B60L 53/20; B60L 2210/10; B60L 2240/545

(57) ABSTRACT

A charging control system includes battery temperature sensors, a battery temperature adjustment device, DC-DC converters, a battery energy control module (BECM), and a powertrain control module (PCM). The battery temperature sensors and the DC-DC converters are provided for each of a plurality of battery modules. In a case where the battery module having a temperature lower than a first temperature exists, the BECM and the PCM determine a warm-up order of the plurality of battery modules to maximize a charging-related requirement for the plurality of battery modules under a predetermined setting condition. In addition, the DC-DC converters are controlled to simultaneously perform charging of the plurality of battery modules at maximum current values set based on their temperatures.

### TECHNICAL FIELD

The present disclosure relates to a charging control system for secondary batteries.

### BACKGROUND ART

Electric vehicles have been known that are vehicles in which a plurality of secondary batteries (hereinafter also simply referred to as batteries) are mounted as a motive power source and that travel with electric power supplied from the batteries. In addition, various techniques for charging the plurality of secondary batteries in a short time have been disclosed (see JP2023-101151A, for example).

JP2023-101151A discloses a configuration in which the plurality of secondary batteries are charged while a heating timing and a charging timing of a battery to be charged are shifted in accordance with the temperature of the battery. In this manner, the total charging time can be reduced.

### SUMMARY

### Technical Problem

Meanwhile, in view of convenience of electric vehicles, it is required to perform more charging in a determined time or to perform charging in a shorter time with respect to a set charging amount. For this goal, it is effective to increase a charging current, but when the temperature of a battery is low, the charging current cannot be increased due to safety concerns. Thus, in a case where charging is performed from an empty state, particularly in wintertime when the temperature of a battery is low, a significant charging amount cannot be obtained in a short time, and it may take several hours including a time taken for warming up the battery to reach a high charging amount, which significantly impairs the convenience of electric vehicles.

For such a problem, in JP2023-101151A, a plurality of secondary batteries constituting a battery pack are sequentially warmed up and charged, and heat of a secondary battery that has completed charging first is transferred to other secondary batteries for which warm-up and charging are insufficient, thereby efficiently warming up the plurality of secondary batteries to shorten a charging time. On the other hand, in a case where there are a plurality of secondary batteries having different temperatures, a time transition of a charging amount changes depending on the warm-up order of the secondary batteries, but this point is not mentioned.

The present disclosure has been made in view of such a point and an object thereof is to provide a charging control system for secondary batteries, which is capable of efficiently warming up and charging an entire battery pack constituted by a plurality of secondary batteries in accordance with settings at the time of charging and their battery temperatures when charging the battery pack.

### Solution to Problem

To achieve the above-described object, a charging control system for secondary batteries according to the present disclosure is a charging control system for a plurality secondary batteries constituting a battery pack, wherein the plurality of secondary batteries included in the battery pack are connected in parallel during traveling, the charging control system includes a plurality of battery temperature sensors that are respectively provided for each of the plurality of secondary batteries and detect temperature of the respective secondary battery, a battery temperature adjustment device configured to switch which of the plurality of secondary batteries is to be warmed up, a plurality of DC-DC converters respectively provided for each of the plurality of secondary batteries and configured to adjust a charging current to be lower as the temperature of the respective secondary battery is lower, and at least one control device that controls each of the battery temperature adjustment device and the DC-DC converters, and in a case where a plurality of the secondary batteries having temperatures lower than a first temperature as a warm-up completion temperature exist among the plurality of secondary batteries, the at least one control device determines a warm-up order for the plurality of secondary batteries to maximize a charging-related requirement as the battery pack under a predetermined setting condition and controls the DC-DC converters so that charging is performed simultaneously with start of initial warm-up and concurrently at maximum current values set based on respective temperatures.

Advantageous Effects

According to the present disclosure, when charging a battery pack constituted by a plurality of secondary batteries, it is possible to efficiently charge the entire battery pack by performing warm-up control based on the temperature state of each battery.

### BRIEF DESCRIPTION OF DRAWINGS

FIG. 1 is a schematic diagram of a main part of a high-voltage system circuit of a vehicle according to Embodiment 1.

FIG. 2 is a functional block diagram illustrating the configuration of a charging control system of the vehicle.

FIG. 3 is a schematic configuration diagram of battery modules including a battery temperature adjustment device.

FIG. 4 is a schematic diagram illustrating a relationship between a state of charge (SOC) of the battery module and charging current.

FIG. 5 is a flowchart illustrating a first charging control procedure and a warm-up control procedure for batteries.

FIG. 6A is a flowchart of a subprocess A.

FIG. 6B is a flowchart of a subprocess B.

FIG. 6C is a flowchart of a subprocess C.

FIG. 6D is a flowchart of a subprocess D.

FIG. 6E is a flowchart of a subprocess E.

FIG. 6F is a flowchart of a subprocess F.

FIG. 7 is a flowchart illustrating a second charging control procedure for batteries.

FIG. 8 is a flowchart illustrating a second warm-up control procedure for batteries, corresponding to the second charging control procedure.

FIG. 9A is a flowchart of a subprocess G.

FIG. 9B is a flowchart of a subprocess H.

FIG. 9C is a flowchart of a subprocess I.

FIG. 10 is a schematic diagram illustrating a battery warm-up order determination procedure and a warm-up completion temperature extraction procedure.

FIG. 11 is a flowchart illustrating a charging amount prediction calculation procedure at a predetermined time point.

FIG. 12 is a diagram illustrating a time-series change of SOC in a case where a warm-up completion temperature and a warm-up order are changed.

FIG. 13 is a diagram illustrating a temporal change of battery temperature in a case where a warm-up is performed from a high-temperature-side battery module.

FIG. 14 is a diagram illustrating a time-series change of SOC in a case where a warm-up is performed from the high-temperature-side battery module.

FIG. 15 is a schematic configuration diagram of another battery module including the battery temperature adjustment device.

FIG. 16 is a diagram illustrating the difference between a battery charging control procedure according to Embodiment 2 and a battery charging control procedure according to Embodiment 1.

FIG. 17 is a diagram illustrating the difference between a battery warm-up control procedure according to Embodiment 2 and a battery warm-up control procedure according to Embodiment 1.

FIG. 18 is a flowchart illustrating a prediction calculation procedure for a charging time until a target SOC is reached.

FIG. 19 is a diagram illustrating time-series change of the SOCs of battery modules A and B in a case where warm-up is performed from the high-temperature-side battery module.

### DETAILED DESCRIPTION

Embodiments of the present disclosure will be described below with reference to the accompanying drawings. Note that the following description of preferable embodiments is essentially merely exemplary and not intended to limit the present disclosure or its applications or usages.

### Embodiment 1

### 1: Configuration of Main Part of Electric Circuit on Vehicle

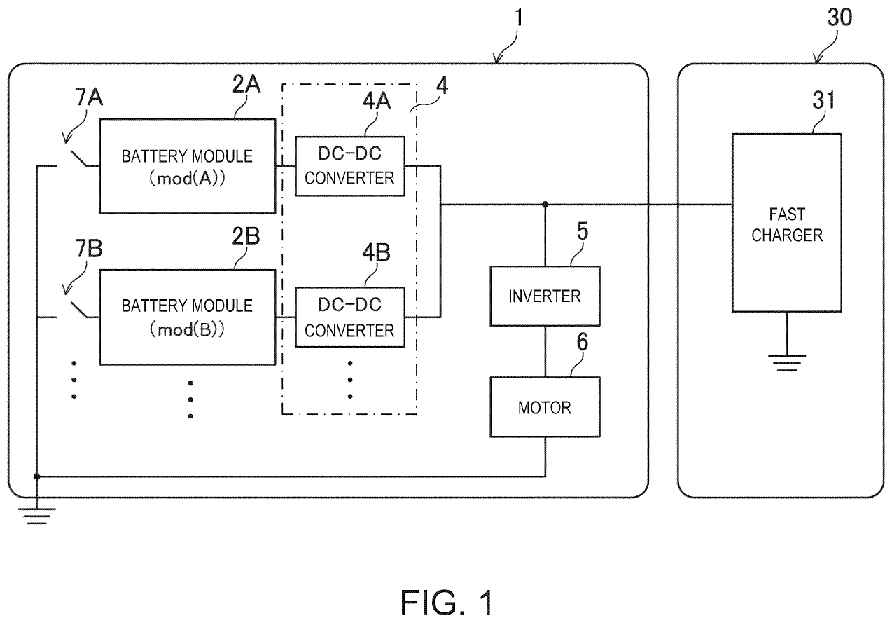

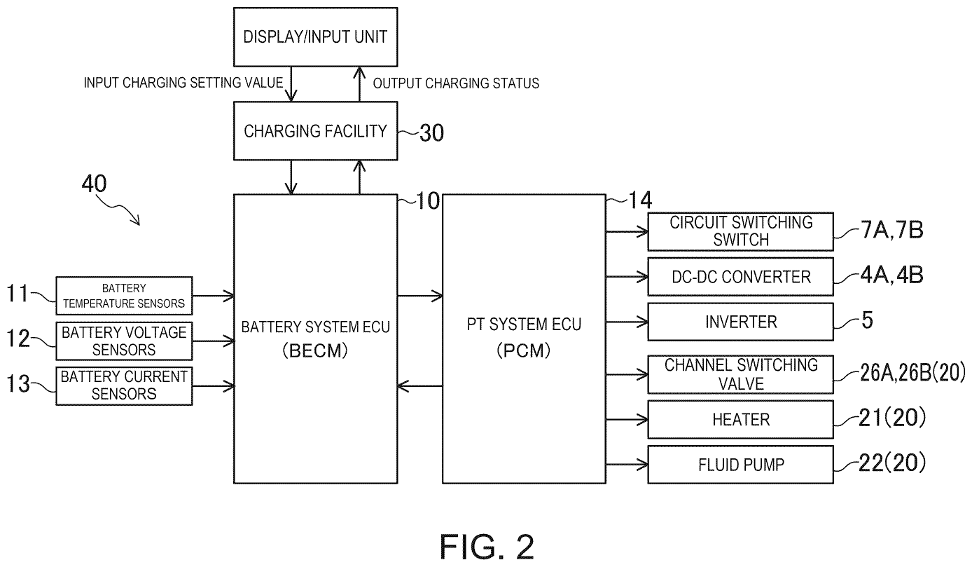

FIG. 1 is a schematic diagram of a main part of a high-voltage system circuit of a vehicle according to Embodiment 1. FIG. 2 is a functional block diagram illustrating the configuration of a charging control system. Note that, for convenience of description, in FIGS. 1 and 2, illustration and description are omitted for electric components and control circuits that are not directly related to battery modules 2A and 2B.

As illustrated in FIG. 1, the high-voltage system circuit in a vehicle 1 includes a pair of battery modules 2A and 2B, a pair of DC-DC converters 4A and 4B, a pair of circuit switching switches 7A and 7B, an inverter 5, and a motor 6. Note that, the battery modules 2A and 2B are also referred to as mod(A) and mod(B) hereinafter. Moreover, the mod(A) and the mod(B) or a plurality of battery modules are also collectively simply referred to as batteries or secondary batteries.

During traveling of the vehicle 1, the circuit switching switches 7A and 7B are both in a closed state. In addition, the mod(A) and the mod(B) are connected to the inverter 5, and their voltages are adjusted by the DC-DC converters 4A and 4B, respectively, and are input to the inverter 5. Direct-current power input to the inverter 5 is converted into alternating-current power and becomes drive power for the motor 6. By driving the motor 6, the vehicle 1 travels. Note that the voltage of each of the mod(A) and the mod(B) at full charge is several hundred volts approximately.

By contrast, when the mod(A) and the mod(B) are charged, the circuit switching switches 7A and 7B are both set to an opened state, and a fast charger 31 provided in a charging facility 30 is electrically connected to the mod(A) and the mod(B). The mod(A) and the mod(B) are each charged with charging current supplied from the fast charger 31. The DC-DC converters 4A and 4B have a function of adjusting the magnitude of the charging current supplied from the fast charger 31 to the mod(A) and the mod(B).

In addition, as illustrated in FIG. 2, the charging control system in the vehicle 1 includes a battery system electronic control unit (ECU) 10 and a powertrain (PT) system ECU 14. Note that the battery system ECU 10 is also referred to as a battery energy control module (BECM) 10. The PT system ECU 14 is also referred to as a powertrain control module (PCM) 14. One or more central processing units (CPUs; not illustrated) are mounted in each of the BECM 10 and the PCM 14. Note that a storage unit (not illustrated) that stores parameters input by a user may be provided in the BECM 10 and/or the PCM 14. The storage unit may temporarily store the parameters. The storage unit may also be provided on the vehicle 1 separately from the BECM 10 and the PCM 14.

A plurality of battery temperature sensors 11, battery voltage sensors 12, and battery current sensors 13 are connected to the BECM 10. A respective battery temperature sensor 11, battery voltage sensor 12, and battery current sensor 13 are provided for each battery module.

In the example illustrated in FIGS. 1 and 2, one of the battery temperature sensors 11 is provided in each of the mod(A) and the mod(B) and detects a temperature of each of the mod(A) and the mod(B). One of the battery voltage sensors 12 is provided in each of the mod(A) and the mod(B) and detects a voltage of each of the mod(A) and the mod(B). One of the battery current sensors 13 is provided in each of the mod(A) and the mod(B) and detects a current of each of the mod(A) and the mod(B). That is, the temperature, voltage, and current of each of the mod(A) and the mod(B) are input to the BECM 10.

In addition, the BECM 10 is configured to transmit and receive signals to and from the charging facility 30. Charging setting conditions related to the mod(A) and the mod(B) are input to the charging facility 30 from a user or a worker of the charging facility, specifically, through an input unit not illustrated, and the setting conditions are further input to the BECM 10. The BECM 10 generates a control signal to the DC-DC converters 4A and 4B based on the input setting conditions and values detected by the respective sensors 11 to 13, and transmits the control signal to the PCM 14. In addition, charging statuses of the mod(A) and the mod(B), for example, the SOCs (state of charge) of the mod(A) and the mod(B) at time point t are transferred from the BECM 10 to the charging facility 30, and are displayed on a display unit not illustrated. Accordingly, the user can check the charging statuses of the mod(A) and the mod(B) based on contents displayed on the display unit.

The circuit switching switches 7A and 7B, the DC-DC converters 4A and 4B, and the inverter 5 are electrically connected to the PCM 14, and the PCM 14 controls operation of each of them. For example, as described above, control signals for the DC-DC converters 4A and 4B, which are generated by the BECM 10, are transferred from the PCM 14 to the DC-DC converters 4A and 4B, respectively.

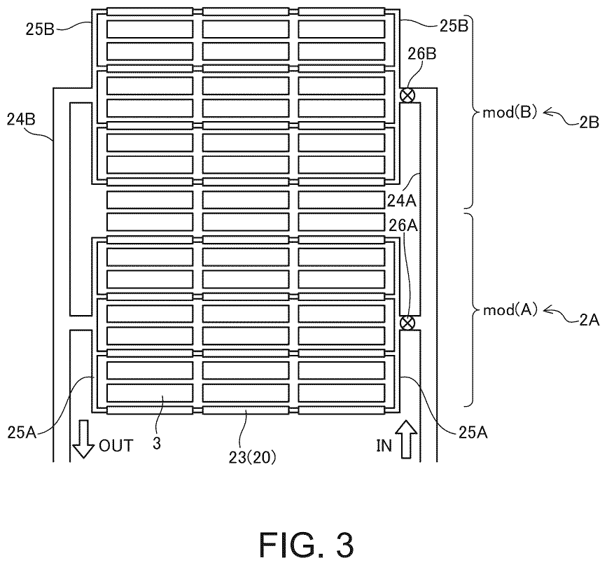

In addition, channel switching valves 26A and 26B (see FIG. 3), a heater 21, and a fluid pump 22 are connected to the PCM 14, and the PCM 14 controls operation of each of them. Operation and function of each of the channel switching valves 26A and 26B, the heater 21, and the fluid pump 22 will be described later.

The BECM 10 and the PCM 14 are configured to be transmit and receive signals to/from each other. Note that drive power for each of the BECM 10 and the PCM 14 is supplied from a low-voltage battery (not illustrated). In many cases, direct-current voltage supplied from the mod(A) and the mod(B) is converted into low voltage by a DC-DC converter, and the low-voltage battery is charged with the converted electric power.

### 2: Configuration of Battery Module Including Battery Temperature Adjustment Device

FIG. 3 is a schematic configuration diagram of battery modules including a battery temperature adjustment device.

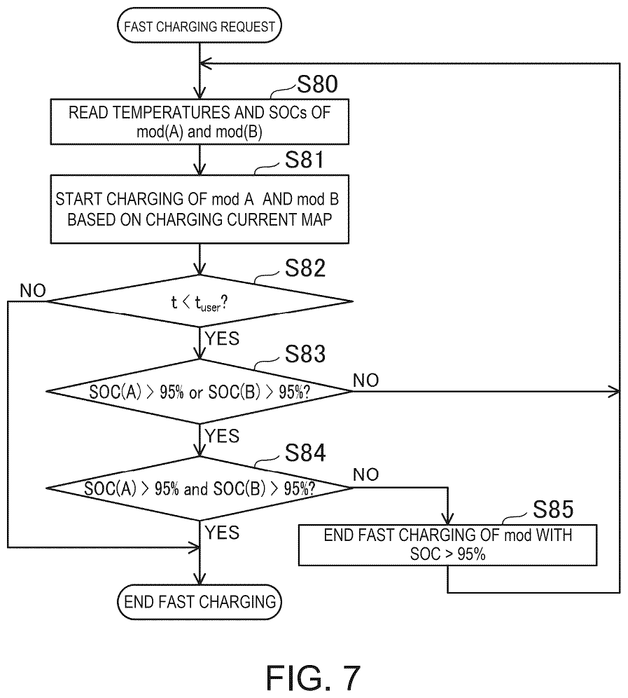

As illustrated in FIG. 3, the mod(A) and the mod(B) each include a plurality of battery cells 3. The plurality of battery cells 3 are disposed in the form of a matrix; in the example illustrated in FIGS. 3, 7 rows and 3 columns, that is, 21 battery cells are disposed for one battery module. The battery cells 3 can be charged and discharged, and the battery cells 3 are, for example, lithium ion secondary batteries.

A temperature adjustment plate 23 is attached to each of the plurality of battery cells 3. Branch pipes are disposed for every two rows in the battery cells 3. That is, two battery cells 3 are disposed in contact with one temperature adjustment plate 23.

A first main pipe 24A is provided on one side of the mod(A) and the mod(B), a second main pipe 24B is provided on the other side, and branch pipes 25A and 25B are provided so as to connect the first main pipe 24A and the second main pipe 24B. Heating water discharged from the fluid pump 22 after being heated to a predetermined temperature by the heater 21 is supplied to the first main pipe 24A. The channel switching valve 26A is provided at a connection part between the first main pipe 24A and the branch pipe 25A. The channel switching valve 26B is provided at a connection part between the second main pipe 24B and the branch pipe 25B. In the example illustrated in FIG. 3, the branch pipe 25A branches into four from the channel switching valve 26A, extends in the row direction of the array of the battery cells 3, and is connected at four points to the second main pipe 24B positioned on a side opposite the channel switching valve 26A with respect to the battery cells 3. When the channel switching valve 26A is in an opened state, heating water is supplied from the first main pipe 24A to each of the four branch pipes 25A. The heating water flowing through the four branch pipes 25A is supplied to each of the temperature adjustment plates 23 disposed in the row direction, and increases the temperature of the battery cells 3 in contact with the temperature adjustment plate 23. The heating water flowing through the branch pipes 25A is collected in the second main pipe 24B, heated again to the predetermined temperature by the heater 21, and then supplied to the first main pipe 24A from the fluid pump 22.

Similarly, the branch pipe 25B branches into four from the channel switching valve 26B, extends in the row direction of the array of the battery cells 3, and is connected at four points to the second main pipe 24B positioned on a side opposite the channel switching valve 26B with respect to the battery cells 3. Heating water flowing through the four branch pipes 25B is supplied to each of the temperature adjustment plates 23 disposed in the row direction, and increases the temperature of the battery cells 3 in contact with the temperature adjustment plates 23. The heating water flowing through the branch pipes 25B is collected in the second main pipe 24B, heated again to the predetermined temperature by the heater 21, and then supplied to the first main pipe 24A from the fluid pump 22.

As is apparent from FIG. 3, the battery cells 3 included in the mod(A) are heated by heating water flowing through the four branch pipes 25A. Similarly, the battery cells 3 included in the mod(B) are heated by heating water flowing through the four branch pipes 25B. In other words, a battery module shown in the present application specification is a set of battery cells 3 warmed up by heating water flowing through the same channel switching valve, that is, a battery pack.

Note that the number of battery cells 3 and the number of rows and columns included in a battery module are not particularly limited to the example illustrated in FIG. 3 and may be changed as appropriate. The numbers of the branch pipes 25A and 25B may be changed as appropriate in accordance with the change in the number of battery cells 3 and the number of rows and columns.

The heater 21, the fluid pump 22, and the temperature adjustment plates 23 function as a battery temperature adjustment device 20 that adjusts the temperatures of the mod(A) and the mod(B). In addition, the channel switching valves 26A and 26B, which are used to determine which of the mod(A) and the mod(B) is to be warmed up, are also part of the battery temperature adjustment device 20.

Note that a resistance heater or a heat pump may be used as the heater 21. In addition, as shown in the present embodiment, the fluid pump 22 is a water pump in a case where heating water is supplied to the temperature adjustment plates 23.

The battery temperature sensors 11 provided in each of the mod(A) and the mod(B), the battery temperature adjustment device 20, the DC-DC converters 4A and 4B connected to the mod(A) and the mod(B), respectively, the BECM 10, and the PCM 14 are also collectively referred to as a charging control system 40.

### 3: Relationship Between SOC of Battery Module and Charging Current

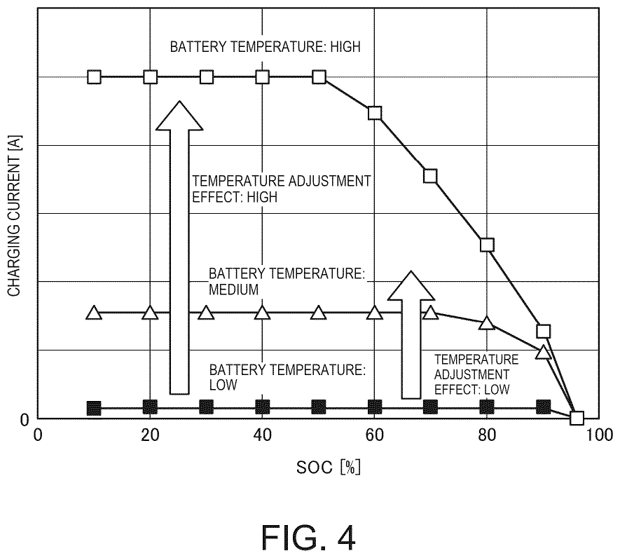

FIG. 4 is a schematic diagram illustrating a relationship between the SOC of a battery module and the charging current. As illustrated in FIG. 4, in charging of the battery module, the charging current that can flow significantly changes in accordance with the temperature of the battery module (hereinafter referred to as a battery temperature). In addition, the charging current that can flow significantly varies also in accordance with the value of the SOC of the battery module. For example, in a case where the battery temperature is low, the value of the charging current that can flow through the battery module is low and substantially constant until the SOC becomes 100%. On the other hand, in a case where the battery temperature is medium, the value of the charging current that can flow through the battery module can be made high compared to the case of the low temperature. In addition, the value of the charging current that can flow is substantially constant until the SOC becomes 70% approximately, and decreases with the increase of the SOC when the SOC exceeds 70%. In addition, in a case where the battery temperature is high, the value of the charging current that can flow through the battery module can be made significantly high compared to the case of the medium temperature. In addition, the value of the charging current that can flow is substantially constant until the SOC becomes 50% approximately, and decreases with the increase of the SOC when the SOC exceeds 50%.

As understood from the above, when charging the mod(A) and the mod(B), the charging current needs to be made lower as the respective temperatures are lower. In other words, when charging the mod(A) and the mod(B), it is possible to perform charging with a high charging current by increasing the respective temperatures from the initial stage of charging while the SOC is low, thereby shortening a charging time. On the other hand, since the heat capacity of each of the mod(A) and the mod(B) is large, the temperatures of the mod(A) and the mod(B) do not abruptly increase even when being warmed up with heating water as described above. When the temperatures have increased to some extent, charging of the mod(A) and the mod(B) has already progressed, and thus the effect (temperature adjustment effect) of shortening the charging time by warm-up is small.

In view of the above, the inventors of the present disclosure have found that, in a case where the temperatures of a plurality of battery modules mounted on the vehicle 1 are low, charging performance of the battery pack can be improved over conventional cases by determining a warm-up order of the battery modules based on a plurality of parameters related to the battery modules instead of concurrently heating the plurality of battery modules. Hereinafter, this will be described with reference to the accompanying drawings.

### 4: First Charging Control Procedure and Warm-Up Control Procedure of Battery Modules

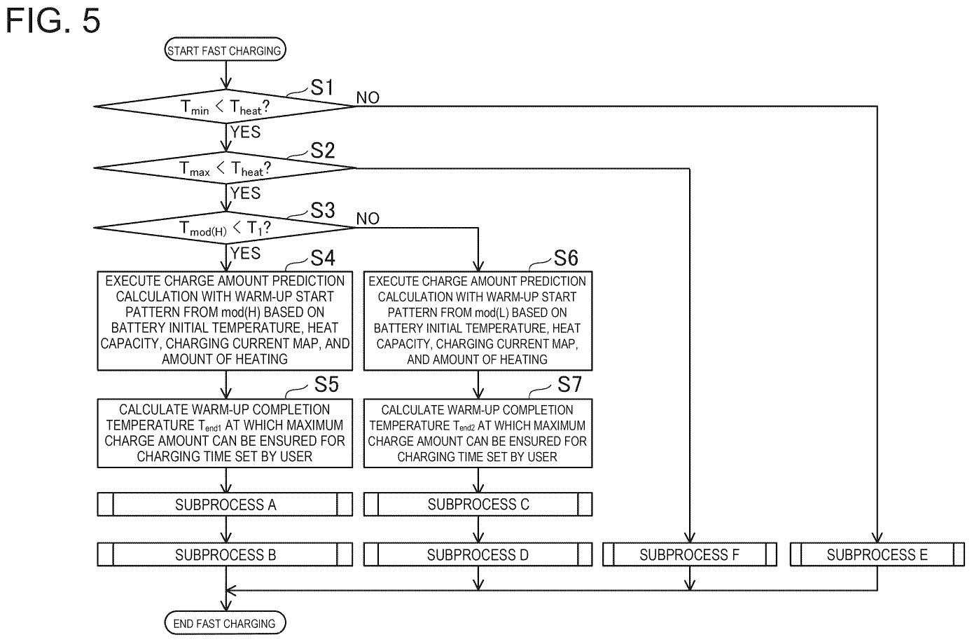

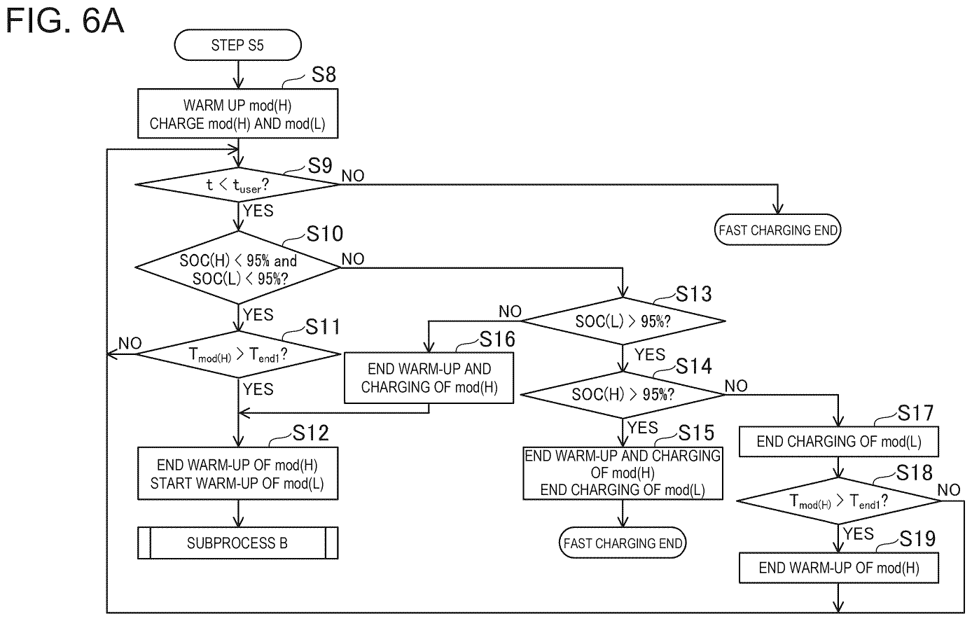

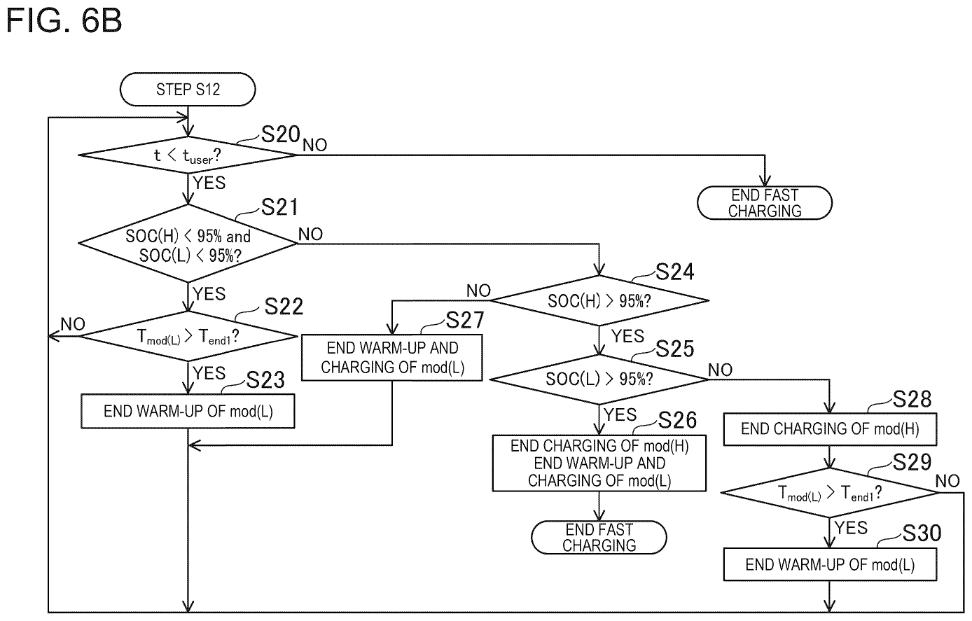

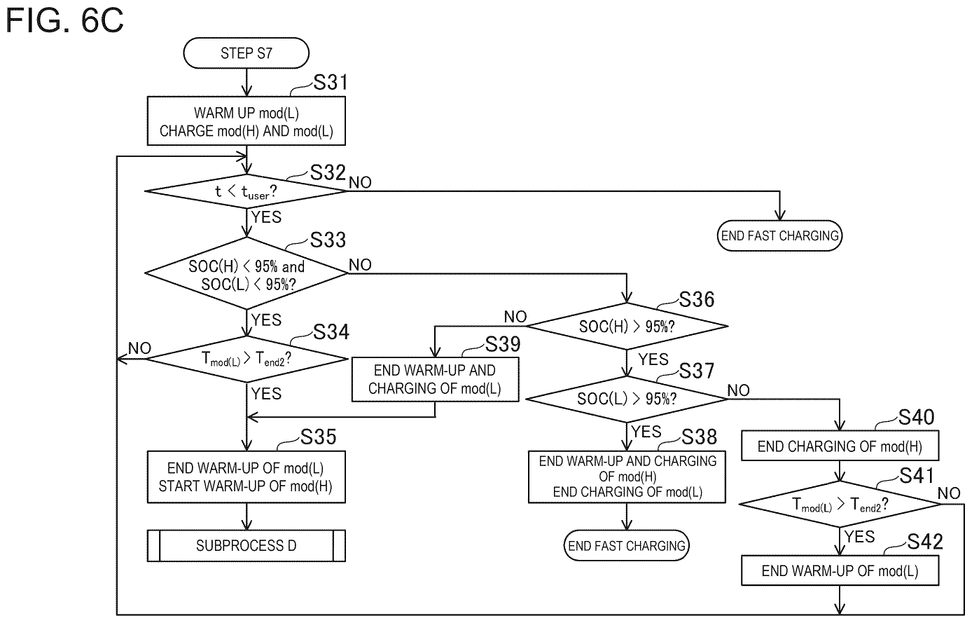

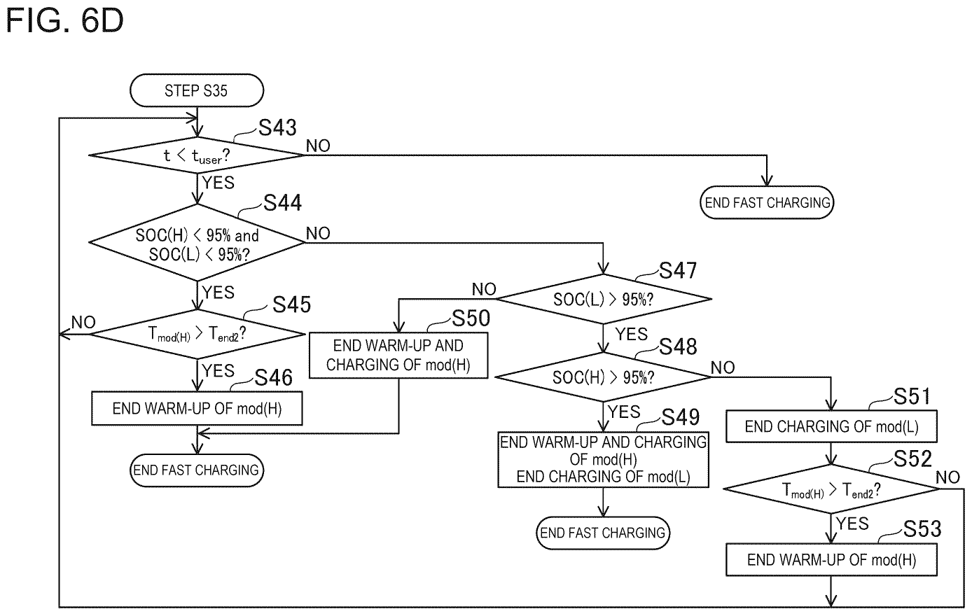

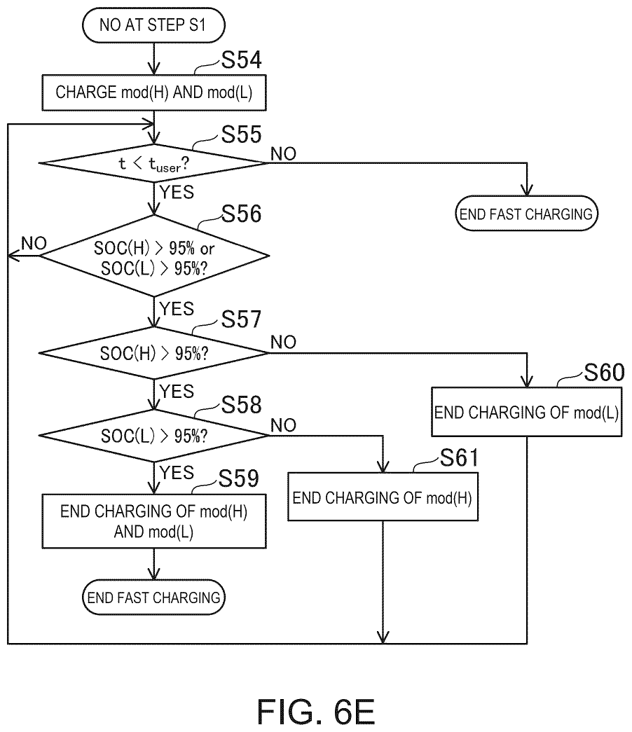

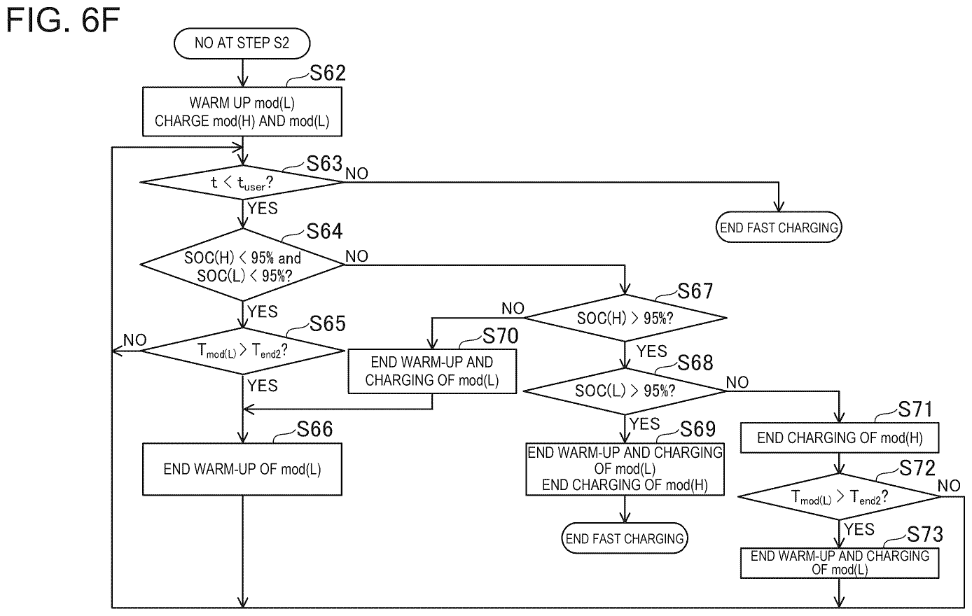

FIG. 5 is a flowchart illustrating a first charging control procedure and a warm-up control procedure for batteries. FIG. 6A is a flowchart of a subprocess A. FIG. 6B is a flowchart of a subprocess B. FIG. 6C is a flowchart of a subprocess C. FIG. 6D is a flowchart of a subprocess D. FIG. 6E is a flowchart of a subprocess E. FIG. 6F is a flowchart of a subprocess F. Note that, in the present embodiment, a charging time tᵤₛₑᵣ for the mod(A) and the mod(B) is set in advance by the user. Since charging of the mod(A) and the mod(B) requires time depending on the number of battery cells 3 and the like, in actual charging, the charging time tᵤₛₑᵣ is often set in order to shorten the charging time.

In the following description, of the mod(A) and the mod(B), one having a higher battery temperature can also be referred to as mod(H), and one having a lower battery temperature can also be referred to as mod(L). Note that, in the present embodiment, it is not excluded that the battery temperature of the mod(H) and the battery temperature of the mod(L) are the same.

A command to start fast charging of the mod(H) and the mod(L) is input to the BECM 10 through an operation by the worker, including the user. As illustrated in FIG. 4, the BECM 10 determines whether the lowest temperature Tₘᵢₙ among the battery temperatures detected by the battery temperature sensors 11 respectively provided in the mod(H) and the mod(L) is lower than a temperature Tₕₑₐₜ, which is a threshold temperature for determining necessity of warm-up (step S1).

In a case where the determination at step S1 is negative, that is, the battery temperatures of the mod(H) and the mod(L) are both equal to or higher than the temperature Tₕₑₐₜ, the process proceeds to the subprocess E (see FIG. 6E).

On the other hand, in a case where the determination at step S1 is positive, that is, at least the battery temperature of the mod(L) is lower than the temperature Tₕₑₐₜ, the BECM 10 determines whether the highest temperature Tₘₐₓ among the battery temperatures detected by the battery temperature sensors 11 is lower than the temperature Tₕₑₐₜ (step S2).

In a case where the determination at step S2 is negative, that is, the mod(L) is lower than the temperature Tₕₑₐₜ but the battery temperature of the mod(H) is equal to or higher than the temperature Tₕₑₐₜ, the process proceeds to the subprocess F (see FIG. 6F).

On the other hand, in a case where the determination at step S2 is positive, that is, the battery temperatures of the mod(H) and the mod(L) are both lower than the temperature Tₕₑₐₜ, the BECM 10 determines whether temperature T_{mod(H)} of the mod(H) is lower than a first temperature T1 (>Tₕₑₐₜ) (step S3). Here, the first temperature T1 is a threshold temperature for determining a warm-up order of the mod(H) and the mod(L). This will be described below.

In a case where the determination at step S3 is negative, that is, the temperature T_{mod(H)} of the mod(H) is higher than the first temperature T1, a charging amount prediction calculation for the battery module is executed based on a plurality of parameters related to the battery module (step S6). Note that the processing at step S6 is executed by the BECM 10. In addition, the charging amount prediction calculation at step S6 is executed on a condition that warm-up is performed in the order of the mod(L)→the mod(H).

After execution of step S6, the BECM 10 subsequently calculates a warm-up completion temperature T_{end2} of the battery module (step S7). The warm-up completion temperature T_{end2} is a battery temperature at which a maximum charging amount can be ensured within the above-described charging time tᵤₛₑᵣ set by the user. After execution of step S7, the process proceeds to the subprocess C (see FIG. 6C), further executes the subprocess D (see FIG. 6D), and then ends fast charging of the mod(H) and the mod(L).

On the other hand, in a case where the determination at step S3 is positive, that is, the temperature T_{mod(H)} of the mod(H) is lower than the first temperature T1, the charging amount prediction calculation for the battery module is executed based on a plurality of parameters related to the battery module (step S4). Note that the processing at step S3 is executed by the BECM 10. In addition, the charging amount prediction calculation at step S4 is executed on a condition that warm-up is performed in the order of the mod(H)→the mod(L).

After execution of step S4, the BECM 10 subsequently calculates a warm-up completion temperature T_{end1} of the battery module (step S5). Similarly to the warm-up completion temperature T_{end2}, the warm-up completion temperature T_{end1} is a battery temperature at which a maximum charging amount can be ensured within a charging time Tᵤₛₑ₁. After execution of step S5, the process proceeds to the subprocess A (see FIG. 6A), further executes the subprocess B (see FIG. 6B), and then ends fast charging of the mod(H) and the mod(L). Note that the processing at steps S4 to S7 will be described later in detail.

### [4-1: Charging Control in a Case Where Warm-Up is Performed From High-Temperature-Side Battery Module]

FIG. 6A is a flowchart of the subprocess A. FIG. 6B is a flowchart of the subprocess B. As described above, the subprocess A and the subprocess B are a charging control procedure and a warm-up control procedure in a case where warm-up is performed in the order of the mod(H)→the mod(L), that is, from the high-temperature-side battery module among the plurality of battery modules.

### [4-1-1: Subprocess A]

The subprocess A is executed in a procedure described below. After execution of step S5, the mod(H) is warmed up, and charging of both the mod(H) and the mod(L) is started (step S8). Subsequently, the BECM 10 determines whether an elapsed time t from the start of charging is shorter than the charging time tᵤₛₑᵣ (step S9).

In a case where the determination result at step S9 is negative, that is, the elapsed time t from the start of charging has reached the above-described charging time tᵤₛₑᵣ, charging of both the mod(H) and the mod(L) is ended.

In a case where the determination result at step S9 is positive, that is, the elapsed time t from the start of charging has not reached the charging time tᵤₛₑᵣ, the BECM 10 determines whether the SOC of the mod(H) (SOC(H)) and the SOC of the mod(L) (SOC(L)) are both less than 95% (step S10).

In a case where the determination result at step S10 is positive, it is subsequently determined whether the battery temperature T_{mod(H)} of the mod(H) is higher than the warm-up completion temperature T_{end1} calculated at step S5 (step S11). The detection result of the battery temperature sensor 11 is used for the determination at step S11.

In a case where the determination result at step S11 is positive, that is, the battery temperature T_{mod(H)} is higher than the warm-up completion temperature T_{end1}, warm-up of the mod(H) is ended and warm-up of the mod(L) is started (step S12), and the process further proceeds to the subprocess B. In a case where the determination result at step S11 is negative, that is, the battery temperature T_{mod(H)} is equal to or lower than the warm-up completion temperature T_{end1}, the process returns to step S9 and repeatedly executes the series of processes at steps S9 to S11 until the determination result at step S11 becomes positive.

On the other hand, in a case where the determination result at step S10 is negative, that is, either the SOC(H) or the SOC(L) is equal to or greater than 95%, the BECM 10 determines whether the SOC(L) exceeds 95% (step S13). In a case where the determination result at step S13 is negative, that is, the SOC(L) is equal to or less than 95%, warm-up and charging of the mod(H) are ended (step S16) and the process proceeds to step S12 to start warm-up of the mod(L) and further proceeds to the subprocess B.

In a case where the determination result at step S13 is positive, the BECM 10 determines whether the SOC(H) exceeds 95% (step S14). In a case where the determination result at step S14 is positive, warm-up and charging of the mod(H) are ended and charging of the mod(L) is ended (step S15). That is, fast charging of the mod(H) and the mod(L) is ended.

On the other hand, in a case where the determination result at step S14 is negative, that is, the SOC(H) is equal to or less than 95%, charging of the mod(L) is ended (step S17), and it is determined whether the battery temperature T_{mod(H)} of the mod(H) is higher than the warm-up completion temperature T_{end1} (step S18). The detection result of the battery temperature sensor 11 is used for the determination at step S18.

In a case where the determination result at step S18 is negative, that is, the battery temperature T_{mod(H)} is equal to or lower than the warm-up completion temperature T_{end1}, the process returns to step S9 and repeatedly executes the series of processes at steps S9 to S11 until the determination result at step S11 becomes positive.

In a case where the determination result at step S18 is positive, warm-up of the mod(H) is ended (step S19), and thereafter, the process returns to step S9 and repeatedly executes the series of processes at steps S9 to S11 until the determination result at step S11 becomes positive.

### [4-1-2: Subprocess B]

The subprocess B is executed in a procedure described below. After execution of step S12, the BECM 10 determines whether the elapsed time t from the start of charging is shorter than the charging time tᵤₛₑᵣ (step S20).

In a case where the determination result at step S20 is negative, that is, the elapsed time t from the start of charging has reached the charging time tᵤₛₑᵣ, charging of both the mod(H) and the mod(L) is ended.

In a case where the determination result at step S20 is positive, that is, the elapsed time t from the start of charging has not reached the charging time tᵤₛₑᵣ, the BECM 10 determines whether the SOC(H) and the SOC(L) are both less than 95% (step S21).

In a case where the determination result at step S21 is positive, it is subsequently determined whether a battery temperature T_{mod(L)} of the mod(L) is higher than the warm-up completion temperature T_{end1} (step S22). The detection result of the battery temperature sensor 11 is used for the determination at step S22.

In a case where the determination result at step S22 is positive, that is, the battery temperature T_{mod(L)} is higher than the warm-up completion temperature T_{end1}, warm-up of the mod(L) is ended (step S23), and the process returns to step S20 and executes the processing at step S20 and the following steps again. In a case where the determination result at step S22 is negative, that is, the battery temperature T_{mod(L)} is equal to or lower than the warm-up completion temperature T_{end1}, the process returns to step S20 and repeatedly executes the series of processes at steps S20 to S22 until the determination result at step S22 becomes positive.

On the other hand, in a case where the determination result at step S21 is negative, that is, either the SOC(H) or the SOC(L) is equal to or greater than 95%, the BECM 10 determines whether the SOC(H) exceeds 95% (step S24). In a case where the determination result at step S24 is negative, that is, the SOC(H) is equal to or less than 95%, warm-up and charging of the mod(L) are ended (step S27), and the process returns to step S20 and executes the processing at step S20 and the following steps again.

In a case where the determination result at step S24 is positive, the BECM 10 determines whether the SOC(L) exceeds 95% (step S25). In a case where the determination result at step S25 is positive, warm-up and charging of the mod(L) are ended and charging of the mod(H) is ended (step S26). That is, fast charging of the mod(H) and the mod(L) is ended.

On the other hand, in a case where the determination result at step S25 is negative, that is, the SOC(L) is equal to or less than 95%, charging of the mod(H) is ended (step S28), and it is determined whether the battery temperature T_{mod(H)} of the mod(L) is higher than the warm-up completion temperature T_{end1} (step S29). The detection result of the battery temperature sensor 11 is used for the determination at step S29.

In a case where the determination result at step S29 is negative, that is, the battery temperature T_{mod(L)} is equal to or lower than the warm-up completion temperature T_{end1}, the process returns to step S20 and repeatedly executes the series of processes at steps S20 to S22 until the determination result at step S22 becomes positive.

In a case where the determination result at step S29 is positive, warm-up of the mod(L) is ended (step S30), and thereafter, the process returns to step S20 and repeatedly executes the series of processes at steps S20 to S22 until the determination result at step S22 becomes positive.

### [4-2: Charging Control in a Case Where Warm-Up is Performed From Low-Temperature-Side Battery Module]

FIG. 6C is a flowchart of the subprocess C. FIG. 6D is a flowchart of the subprocess D. As described above, the subprocess C and the subprocess D are a charging control procedure and a warm-up control procedure in a case where warm-up is performed in the order of the mod(L)→the mod(H), that is, from the low-temperature-side battery module among the plurality of battery modules.

The processing procedure of the subprocess C illustrated in FIG. 6C, that is, the processing at steps S31 to S42 is the same flow as the processing procedure of the subprocess A illustrated in FIG. 6A, that is, the processing at steps S8 to S19. In addition, the processing procedure of the subprocess D illustrated in FIG. 6D, that is, the processing at steps S43 to S53 is the same flow as the processing procedure of the subprocess B illustrated in FIG. 6B, that is, the processing at steps S20 to S30.

However, unlike the subprocesses A and B, warm-up is performed from the low-temperature-side battery module among the plurality of battery modules, and thus, the contents of steps in the subprocesses C and D may be different from those in the subprocesses A and B, respectively.

Specifically, processing individually performed for the mod(H) in the subprocesses A and B is replaced with processing individually performed for the mod(L) in the subprocesses C and D. Similarly, processing individually performed for the mod(L) in the subprocesses A and B is replaced with processing individually performed for the mod(H) in the subprocesses C and D.

For example, the start of warm-up of the mod(H) at step S8 is replaced with the start of warm-up of the mod(L) at step S31. In addition, the end of warm-up of the mod(L) at step S23 is replaced with the end of warm-up of the mod(H) at step S46.

In addition, processing related to parameters of the mod(H) in the subprocesses A and B is replaced with processing related to parameters of the mod(L) in the subprocesses C and D. Similarly, processing related to parameters of the mod(L) in the subprocesses A and B is replaced with processing related to parameters of the mod(H) in the subprocesses C and D.

For example, determination processing of the magnitude relationship between the battery temperature T_{mod(H)} of the mod(H) and the warm-up completion temperature T_{end1} at step S11 is replaced with determination processing of the magnitude relationship between the battery temperature T_{mod(L)} of the mod(L) and the warm-up completion temperature T_{end2} at step S34. In addition, determination processing of the magnitude relationship between the battery temperature T_{mod(L)} of the mod(L) and the warm-up completion temperature T_{end1} at step S22 is replaced with determination processing of the magnitude relationship between the battery temperature T_{mod(H)} of the mod(H) and the warm-up completion temperature T_{end2} at step S45.

### [4-3: Charging Control in a Case Where Warm-Up is Not Performed]

FIG. 6E is a flowchart of the subprocess E. The subprocess E is a charging control procedure and a warm-up control procedure in a case where warm-up is not performed for a plurality of battery modules.

In a case where it is determined that the temperatures of the mod(H) and the mod(L) are both equal to or higher than the temperature Tₕₑₐₜ at step S1, charging of both the mod(H) and the mod(L) is started (step S54). Subsequently, the BECM 10 determines whether the elapsed time t from the start of charging is shorter than the charging time tᵤₛₑᵣ (step S55).

In a case where the determination result at step S55 is negative, that is, the elapsed time t from the start of charging has reached the charging time tᵤₛₑᵣ, fast charging of both the mod(H) and the mod(L) is ended.

In a case where the determination result at step S55 is positive, that is, the elapsed time t from the start of charging has not reached the charging time tᵤₛₑᵣ, the BECM 10 determines whether either the SOC(H) or the SOC(L) exceeds 95% (step S56).

In a case where the determination result at step S56 is negative, the process returns to step S55 and repeatedly executes the processing at steps S55 and S56 until the determination result at step S57 becomes positive.

In a case where the determination result at step S56 is positive, the BECM 10 determines whether the SOC(H) exceeds 95% (step S57). In a case where the determination result at step S58 is negative, charging of the mod(L) is ended (step S60), and the process returns to step S55 and repeatedly executes the series of processes at steps S55 to S57 until the determination result at step S58 becomes positive.

On the other hand, in a case where the determination result at step S57 is positive, the BECM 10 determines whether the SOC(L) exceeds 95% (step S58). In a case where the determination result at step S58 is negative, charging of the mod(H) is ended (step S61), and the process returns to step S55 and repeatedly executes the series of processes at steps S56 to S58 until the determination result at step S58 becomes positive. In a case where the determination result at step S58 is positive, fast charging of both the mod(H) and the mod(L) is ended (step S59).

### [4-4: Charging Control in a Case Where Warm-Up is Performed Only for Mod(L)]

FIG. 6F is a flowchart of the subprocess F. The subprocess F is a charging control procedure and a warm-up control procedure in a case where warm-up is performed only for the mod(L).

The processing procedure of the subprocess F illustrated in FIG. 6F, that is, the processing at steps S62 to S73 is the same flow as the processing procedure of the subprocess C illustrated in FIG. 6C, that is, the processing at steps S31 to S42.

However, since, unlike the subprocess C, warm-up is performed only for the low-temperature-side battery module among the plurality of battery modules, the contents of steps in the subprocess F may be different from those in the subprocess C, respectively.

Specifically, processing individually performed for the mod(H) in the subprocess F is replaced only with processing related to charging of the mod(H) in the subprocess C. Similarly, processing individually performed for the mod(L) in the subprocess F is replaced with processing individually performed for the mod(L) in the subprocess C.

For example, the start of warm-up of the mod(H) at step S35 is omitted at step S66.

In addition, processing related to parameters of the mod(H) in the subprocess F is replaced with processing related to parameters except for temperature used for warm-up processing of the mod(H) in the subprocess C. In addition, processing related to parameters of the mod(L) in the subprocess F is replaced with processing related to parameters of the mod(L) in the subprocess C.

For example, the processing of ending warm-up and charging of the mod(H) and ending charging of the mod(L) at step S38 is replaced with processing of ending warm-up and charging of the mod(L) and ending charging of the mod(H) at step S69.

### 5: Second Charging Control Procedure and Warm-Up Control Procedure for Battery Modules

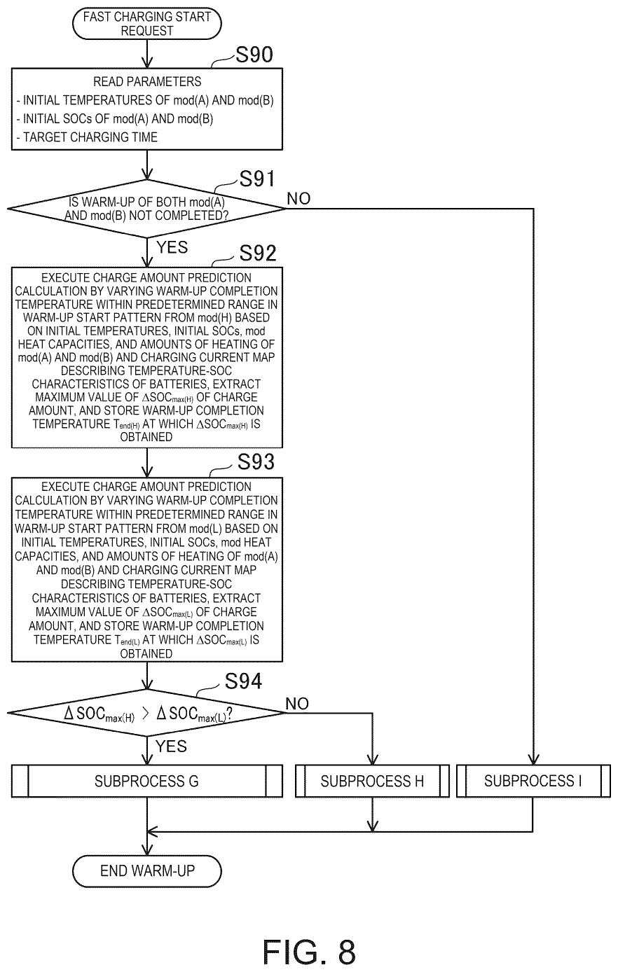

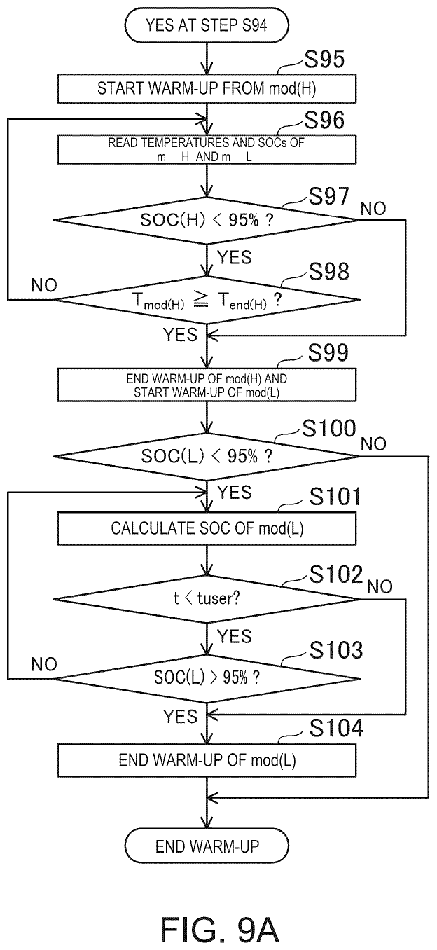

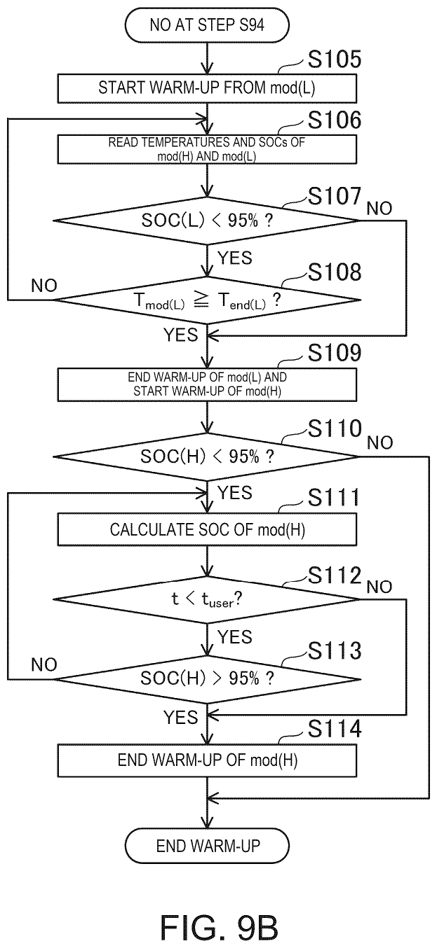

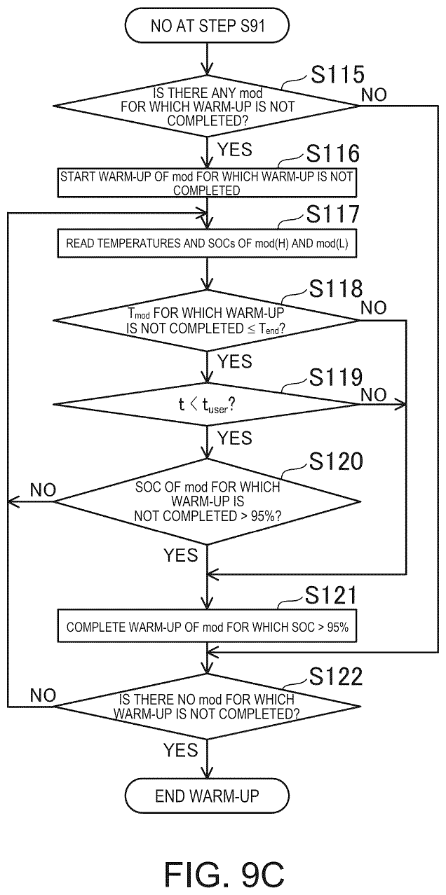

FIG. 7 is a flowchart illustrating a second charging control procedure for batteries. FIG. 8 is a flowchart illustrating a second warm-up control procedure for batteries, corresponding to the second charging control procedure. FIGS. 9A to 9C are flowcharts of subprocesses G to I.

As illustrated in FIG. 7, in the second charging control procedure, the BECM 10 reads the battery temperatures and SOCs of the mod(A) and the mod(B) based on the detection results of the battery temperature sensor 11, the battery voltage sensor 12, and the battery current sensor 13 (step S80). In addition, charging of both the mod(A) and the mod(B) is started based on a charging current map to be described later (step S81). Subsequently, the BECM 10 determines whether the elapsed time t from the start of charging is shorter than the charging time tᵤₛₑᵣ (step S82). In a case where the determination result at step S82 is positive, the BECM 10 determines whether either the SOC(A) or the SOC(B) exceeds 95% (step S83). On the other hand, in a case where the determination result at step S82 is negative, that is, the elapsed time t from the start of charging has reached the charging time tᵤₛₑᵣ, fast charging of both the mod(A) and the mod(B) is ended.

In a case where the determination result at step S83 is positive, the BECM 10 determines whether the SOC(A) and the SOC(B) both exceed 95% (step S84). On the other hand, in a case where the determination result at step S83 is negative, that is, in a case where the SOC(A) and the SOC(B) both do not exceed 95%, the process returns to step S80 and repeatedly executes the series of processes at steps S80 to S83 until the determination result at step S83 becomes positive.

In a case where the determination result at step S84 is positive, fast charging of both the mod(A) and the mod(B) is ended. On the other hand, in a case where the determination result at step S84 is negative, fast charging of any battery module the SOC of which exceeds 95% is ended (step S85), and the process returns to step S80 and repeatedly executes the series of processes at steps S80 to S84 until the determination result at step S84 becomes positive.

The battery charging control procedure illustrated in FIG. 7 and the battery warm-up control procedure illustrated in FIGS. 8 and 9A to 9C correspond to the battery charging control procedure and the warm-up control procedure illustrated in FIGS. 5 and 6A to 6F. However, in the flowchart illustrated in FIG. 5, at steps S1 and S2, it is determined whether the temperature Tₘᵢₙ is lower than the temperature Tₕₑₐₜ, and also whether the temperature Tₘₐₓ is lower than the temperature Tₕₑₐₜ, and the warm-up order of battery modules is determined in accordance with the determination results of them. On the other hand, in the flowchart illustrated in FIG. 8, the warm-up order of battery modules is determined in accordance with the magnitude relationship between charging amount maximum values ΔSOC(H) and ΔSOC(L) to be described later. This will be described below.

As illustrated in FIG. 8, the BECM 10 reads various parameters input by a worker, including the user (step S90). The parameters are the initial temperatures of the mod(A) and the mod(B), initial SOCs, amounts of heating provided for warm-up, and the heat capacities of the mod(A) and the mod(B). Step S80 illustrated in FIG. 7 corresponds to part of step S90. In addition, a charging time as a target (target charging time) is input as well. Note that temperature increase rates may be input in place of the amounts of heating.

Subsequently, the BECM 10 determines whether warm-up is not completed for both the mod(A) and the mod(B) (step S91). Step S91 is determined based on the detection results of the battery temperature sensors 11. In a case where the determination result at step S91 is negative, that is, at least one of the mod(A) and the mod(B) is warmed up, the process proceeds to a subprocess I.

In a case where the determination result at step S91 is positive, that is, the mod(A) and the mod(B) are both not warmed up, the BECM 10 executes charge amount prediction calculation based on the various parameters read at step S90 and the above-described heat capacities of the mod(A) and the mod(B) (step S92). This calculation is performed by varying the warm-up completion temperature within a predetermined temperature range in the above-described pattern in which warm-up is started from the mod(H). In addition, a charge amount maximum value ΔSOC_{max(H)} is extracted as an execution result of the prediction calculation. In addition, a warm-up completion temperature T_{end(H)} at which ΔSOC_{max(H)} is obtained is extracted and stored in the above-described storage unit.

After execution of step S92, the BECM 10 executes charge amount prediction calculation based on the various parameters read at step S90, the charging current map to be described later, and the heat capacities of the mod(A) and the mod(B) (step S93). This calculation is performed by varying the warm-up completion temperature within a predetermined temperature range in the above-described pattern in which warm-up is started from the mod(L). In addition, a charge amount maximum value ΔSOC_{max(L)} is extracted as an execution result of the prediction calculation. In addition, a warm-up completion temperature T_{end(L)} at which ΔSOC_{max(L)} is obtained is extracted and stored in the above-described storage unit.

The processing at steps S92 and S93 corresponds to the above-described processing at steps S4 to S7. Details of the processing will be described later. Note that the heat capacities and the charging current map are stored in the storage unit in advance and read by a central processing unit (CPU) provided in the BECM 10 at execution of steps S92 and S93. Note that the heat capacities may be input by the user at step S90.

Subsequently, the BECM 10 determines whether ΔSOC_{max(H)} is larger than ΔSOC_{max(L)} (step S94). The process proceeds to a subprocess G in a case where the determination result at step S94 is positive, or the process proceeds to a subprocess H in a case where the determination result is negative.

### [5-1: Subprocess G]

The subprocess G is a warm-up control procedure in a case where warm-up is not completed for any of the plurality of battery modules and warm-up is performed in the order of the mod(H)→the mod(L), that is, from the high-temperature-side battery module.

In a case where ΔSOC_{max(H)} is larger than ΔSOC_{max(L)} , the PCM 14 starts warm-up from the mod(H) (step S95). Subsequently, the BECM 10 reads the battery temperature of each of the mod(H) and the mod(L) and calculates the SOC (step S96). The battery temperatures are read from the detection results of the battery temperature sensors 11, and the SOCs are calculated based on the detection results of the battery voltage sensors 12 and the battery current sensors 13.

Subsequently, the BECM 10 determines whether the SOC(H) is less than 95% (step S97). In a case where the determination result at step S97 is positive, the process proceeds to step S98. On the other hand, in a case where the determination result at step S97 is negative, that is, the SOC(H) is equal to or greater than 95%, the process proceeds to step S99 to end warm-up of the mod(H) and start warm-up of the mod(L).

At step S98, it is determined whether the battery temperature T_{mod(H)} of the mod(H) is equal to or higher than the warm-up completion temperature T_{end(H)} extracted at step S92. In a case where the determination result at step S98 is positive, the process proceeds to step S99 to end warm-up of the mod(H) and start warm-up of the mod(L). On the other hand, in a case where the determination result at step S98 is negative, that is, the battery temperature T_{mod(H)} is lower than the warm-up completion temperature T_{end(H)} , the process returns to step S96 and repeatedly executes the series of processes at steps S96 to S98 until the determination result at step S98 becomes positive.

After execution of step S99, the BECM 10 determines whether the SOC(L) is less than 95% (step S100). In a case where the determination result at step S100 is positive, the process proceeds to step S101. On the other hand, in a case where the determination result at step S100 is negative, that is, the SOC(L) is equal to or greater than 95%, warm-up of both the mod(H) and the mod(L) is ended.

At step S101, the SOC of the mod(L), that is, the SOC(L) is calculated. In addition, the BECM 10 determines whether the elapsed time t from the start of charging is shorter than the target charging time tᵤₛₑᵣ input by the user at step S90 (step S102). In a case where the determination result at step S102 is positive, the process proceeds to step S103. In a case where the determination result at step S102 is negative, that is, the elapsed time t has reached the target charging time tᵤₛₑᵣ, warm-up of the mod(L) is ended (step S104) and warm-up of both the mod(H) and the mod(L) is ended.

At step S103, it is determined whether the SOC(L) exceeds 95%. In a case where the determination result at step S103 is positive, warm-up of the mod(L) is ended (step S104) and warm-up of both the mod(H) and the mod(L) is ended. On the other hand, in a case where the determination result at step S103 is negative, that is, the SOC(L) is equal to or less than 95%, the process returns to step S101 and repeatedly executes the series of processes at steps S101 to S103 until the determination result at step S103 becomes positive.

### [5-2: Subprocess H]

The subprocess H is a warm-up control procedure in a case where warm-up is not completed for any of the plurality of battery modules and warm-up is performed in the order of the mod(L)→the mod(H), that is, the low-temperature-side battery module.

The processing procedure of the subprocess H illustrated in FIG. 9B, that is, the processing at steps S105 to S114 is the same flow as the processing procedure of the subprocess G illustrated in FIG. 9A, that is, the processing at steps S95 to S104.

However, unlike the subprocess G, since warm-up is performed from the low-temperature-side battery module among the plurality of battery modules, the contents of steps in the subprocess H may be different from those in the subprocess G, respectively.

Specifically, processing individually performed for the mod(H) in the subprocess G is replaced with processing individually performed for the mod(L) in the subprocess H. Similarly, processing individually performed for the mod(L) in the subprocess G is replaced with processing individually performed for the mod(H) in the subprocess H.

For example, the processing of starting warm-up from the mod(H) at step S95 is replaced with processing of starting warm-up from the mod(L) at step S105. In addition, the processing of ending warm-up of the mod(H) and starting warm-up of the mod(L) at step S99 is replaced with processing of ending warm-up of the mod(L) and starting warm-up of the mod(H) at step S109.

In addition, processing related to parameters of the mod(H) in the subprocess G is replaced with processing related to parameters of the mod(L) in the subprocess H. Similarly, processing related to parameters of the mod(L) in the subprocess G is replaced with processing related to parameters of the mod(H) in the subprocess H.

For example, the determination processing of the magnitude relationship between the battery temperature T_{mod(H)} and the warm-up completion temperature T_{end(H)} of the mod(H) at step S98 is replaced with determination processing of the magnitude relationship between the battery temperature T_{mod(L)} and the warm-up completion temperature T_{end(L)} of the mod(L) at step S108. In addition, the determination processing related to the range of the SOC(L) at step S100 is replaced with determination processing related to the range of the SOC(H) at step S110.

### [5-3: Subprocess I]

The subprocess I is a warm-up control procedure in a case where warm-up is performed for any battery module for which warm-up is not completed in a case where warm-up is completed for at least one of the plurality of battery modules.

In a case where the determination result at step S91 is negative, the PCM 14 or the BECM 10 determines whether there is any battery module for which warm-up is not completed (step S115). In a case where the determination result at step S115 is negative, the process proceeds to step S122. On the other hand, in a case where the determination result at step S115 is positive, warm-up of the battery module for which warm-up is not completed is started (step S116), and the battery temperature of each of the mod(H) and the mod(L) is read and the SOC is calculated in the same procedure as that shown at step S96 (step S117).

Subsequently, the BECM 10 determines whether a battery temperature T_{mod} of the battery module for which warm-up is not completed is equal to or lower than a warm-up completion temperature T_{end} (step S118). Note that the warm-up completion temperature T_{end} is determined based on the warm-up completion temperature T_{end(H)} and the warm-up completion temperature T_{end(L)} described above.

In a case where the determination result at step S118 is negative, that is, the battery temperature T_{mod} is higher than the warm-up completion temperature T_{end}, warm-up of the battery module the SOC of which exceeds 95% is completed (step S121). On the other hand, in a case where the determination result at step S118 is positive, the BECM 10 subsequently determines whether the elapsed time t from the start of charging is shorter than the target charging time tᵤₛₑᵣ (step S119). In a case where the determination result at step S119 is positive, the process proceeds to step S120. In a case where the determination result at step S119 is negative, that is, the elapsed time t has reached the target charging time tᵤₛₑᵣ, the process proceeds to step S121 and completes warm-up of the battery module the SOC of which exceeds 95%.

At step S120, the BECM 10 determines whether the SOC of the battery module for which warm-up is not completed exceeds 95%. In a case where the determination result at step S120 is positive, the process proceeds to step S121 and completes warm-up of the battery module the SOC of which exceeds 95%. On the other hand, in a case where the determination result at step S120 is negative, the process returns to step S117 and repeatedly executes the series of processes at steps S117 to S120 until the determination result at step S120 becomes positive.

After execution of step S121, the BECM 10 determines whether there is any battery module for which warm-up is not completed (step S122). In a case where the determination result at step S122 is negative, that is, there is any battery module for which warm-up is not completed, the process returns to step S117 and repeatedly executes the series of processes at steps S117 to S122 until the determination result at step S122 becomes positive. On the other hand, in a case where the determination result at step S122 is positive, that is, there is no battery module for which warm-up is not completed, warm-up of both the mod(H) and the mod(L) is ended.

### 6: Battery Warm-Up Order Determination Procedure, Charge Amount Prediction Calculation Procedure, and Warm-Up Completion Temperature Extraction Procedure

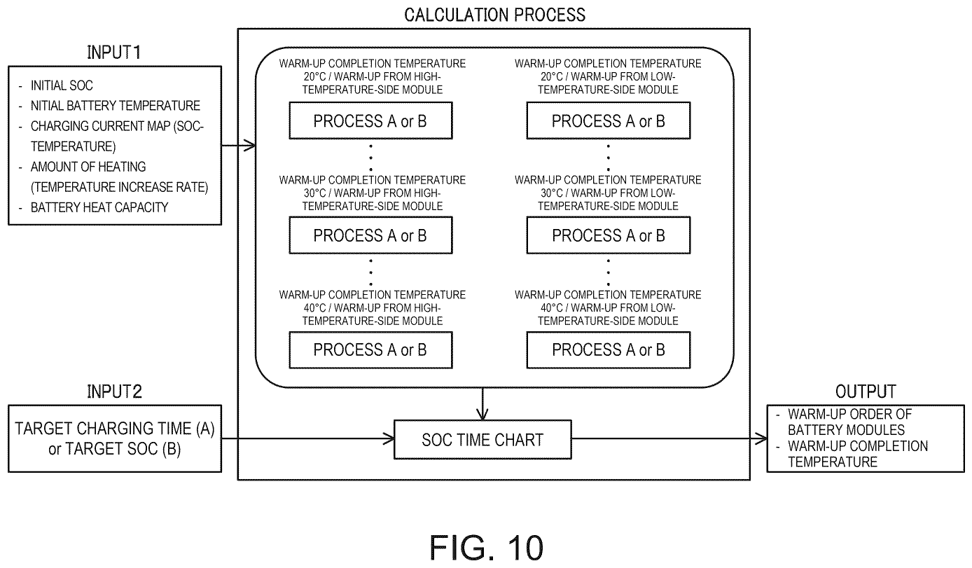

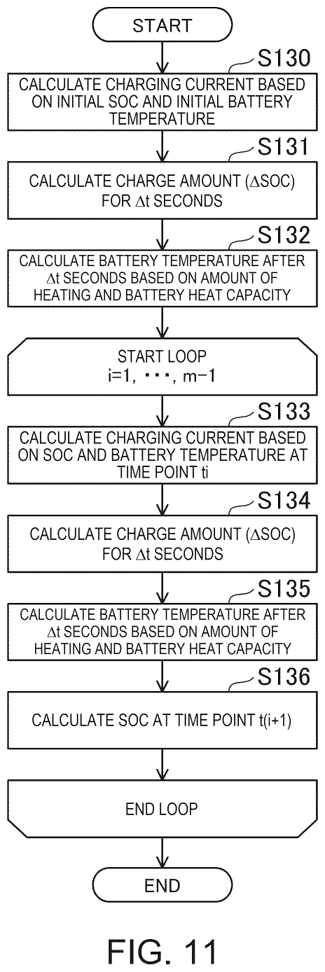

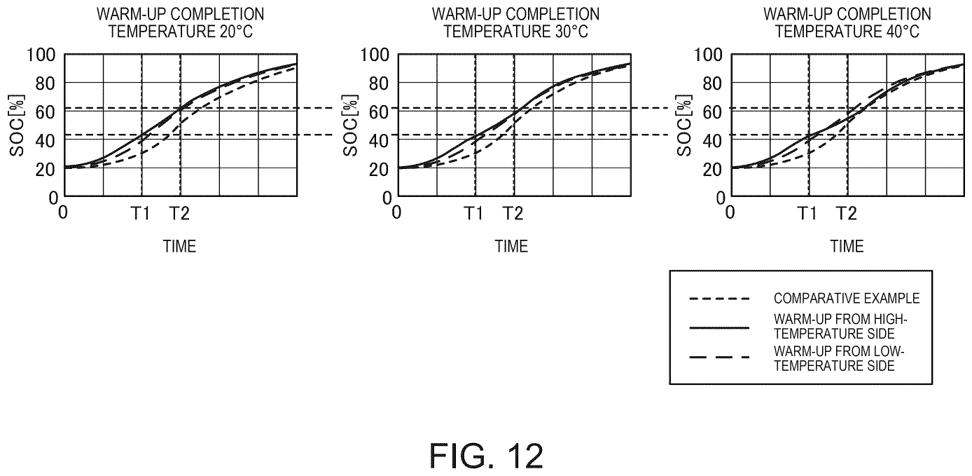

FIG. 10 is a schematic diagram illustrating a battery warm-up order determination procedure and a warm-up completion temperature extraction procedure. FIG. 11 is a flowchart illustrating a charge amount prediction calculation procedure at a predetermined time point. FIG. 12 is a diagram illustrating SOC time-series change in a case where the warm-up completion temperature and the warm-up order are changed.

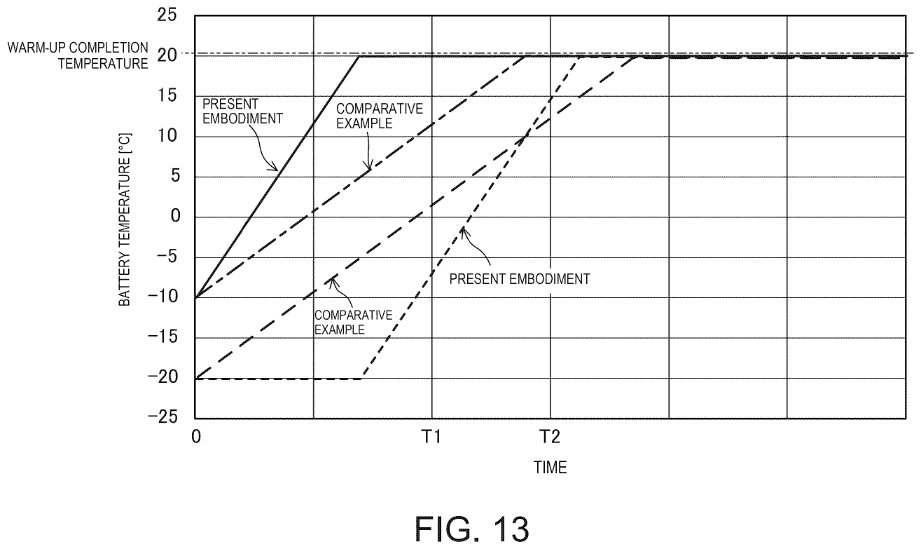

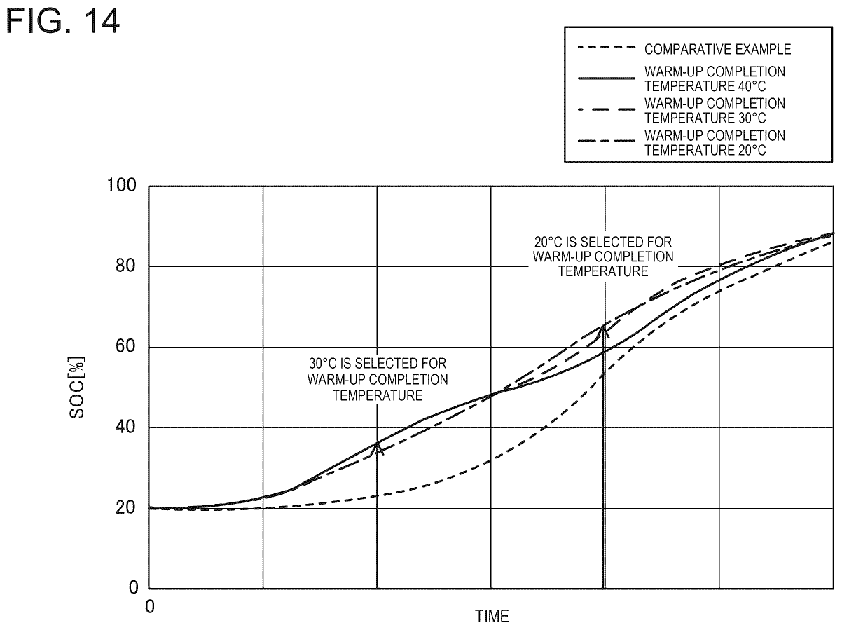

FIG. 13 is a diagram illustrating temporal change of the battery temperature in a case where warm-up is performed from the high-temperature-side battery module. FIG. 14 is a diagram illustrating time-series change of the SOC in a case where warm-up is performed from the high-temperature-side battery module. Note that comparative examples illustrated in FIGS. 13 and 14 show time-series change of the battery temperature and the SOC, respectively, in a case where the mod(H) and the mod(L) are simultaneously warmed up.

Note that the battery charge amount prediction calculation procedure corresponds to steps S92 and S93 in FIG. 8. In addition, the procedure also corresponds to steps S4 and S6 in FIG. 5. The warm-up completion temperature extraction procedure corresponds to steps S92 and S93 in FIG. 8. In addition, the procedure also corresponds to steps S5 and S7 in FIG. 5.

When the warm-up order of the plurality of battery modules is to be determined and the warm-up completion temperature is to be extracted, an initial input condition (INPUT1) is determined as illustrated in FIG. 10. Specifically, the battery SOC (initial SOC) before charging, the battery temperature (initial battery temperature) before charging, the charging current map, the battery heating amount or temperature increase rate, and the battery heat capacity are input. The charging current map is numerical data describing the relationship between the SOC and the charging current when the battery temperature is changed, and corresponds to numerical data for deriving the graph illustrated in FIG. 4.

In addition, a target charging time or a target SOC is input as a charging setting condition (INPUT2). In the present embodiment, a case where the target charging time is input is considered.

When the initial input condition and the charging setting condition are input, the BECM 10 calculates time-series change in the SOC in accordance with a process (process A) illustrated in FIG. 11. Further description will be given with reference to FIG. 11.

First, charging current is calculated based on the charging current map, specifically, the initial SOC and the initial battery temperature (step S130). Subsequently, a charge amount ΔSOC until Δt seconds elapse since the start of charging is calculated (step S131), and further, the battery temperature after Δt seconds from the start of charging is calculated based on the amount of heating and the battery heat capacity (step S132).

A series of processes at steps S133 to S136 described below is repeatedly executed (m-1) times. Here, when tᵤₛₑᵣ represents the target charging time, m is the smallest integer that satisfies Expression (1) below.

$$m \times Δ t \geq {t}_{user} \qquad ( 1 )$$

Charging current is calculated based on the SOC and the battery temperature at a time point ti (step S133). Subsequently, the charge amount ΔSOC until Δt seconds elapse since the time point ti is calculated (step S134), and further the battery temperature after Δt seconds from the time point ti is calculated based on the amount of heating and the battery heat capacity (step S135). The SOC at a time point t(i+1) is calculated (step S136).

In addition, as illustrated in FIG. 10, the process A is executed for each combination of the warm-up order, that is, a selection of whether to perform warm-up from the high-temperature-side battery module, to perform warm-up from the low-temperature-side battery module, or to warm up all battery modules similarly, and the warm-up completion temperature. As an execution result, SOC time-series change in a case where the warm-up completion temperature and the warm-up order are changed, that is, a group of SOC time charts, are obtained. FIG. 12 shows one example thereof.

As illustrated in FIG. 12, the SOC time charts change depending on the warm-up completion temperature. It was also found that the warm-up completion temperature at which a larger charge amount can be ensured changes due to difference in the warm-up order. In addition, it was found that the warm-up completion temperature at which a larger charge amount can be ensured changes in accordance with the charging time.

In the example illustrated in FIG. 12, the warm-up completion temperature at which the greatest charge amount can be ensured is 30° C. in a case where the charging time is T1, whereas the warm-up completion temperature at which the greatest charge amount can be ensured is 20° C. in a case where the charging time is T2 (>T1).

The warm-up order of battery modules and the warm-up completion temperature are determined based on the group of SOC time charts obtained through the above-described procedure and a target charging time set in advance, and execution results of the processing at steps S4 to S7 and the processing at steps S92 and S93 are obtained.

For example, in a case where warm-up is performed from the high-temperature-side battery module as illustrated in FIG. 13, the warm-up completion temperature is selected as appropriate in accordance with the charging time, as illustrated in FIG. 14, and charging control (see FIGS. 6A and 6B) and warm-up control (see FIG. 9A) of the mod(H) and the mod(L) are sequentially executed.

Note that, as shown with the comparative example in FIG. 13, in a case where warm-up is performed from the high-temperature-side battery module as shown in the present embodiment (see FIG. 13), both the mod(H) and the mod(L) can be heated to the warm-up completion temperature in a shorter time as compared to a case where the mod(H) and the mod(L) are simultaneously warmed up. However, in a case where the battery temperature T_{mod(H)} of the mod(H) is equal to or higher than a predetermined value, the effect (temperature adjustment effect) of shortening the charging time due to warm-up is small as illustrated in FIG. 4. Thus, depending on a set charging time, the total charge amount of the mod(H) and the mod(L) can be increased by performing warm-up from the low-temperature-side battery module, in some cases.

### 7: Variations of Configuration of Battery Module

Note that the number of battery modules mounted on the vehicle 1 is not particularly limited to the example illustrated in FIG. 1. From the perspective of supplying electric power needed for traveling of the vehicle 1 by one-time charging, the number of battery modules may be changed as appropriate.

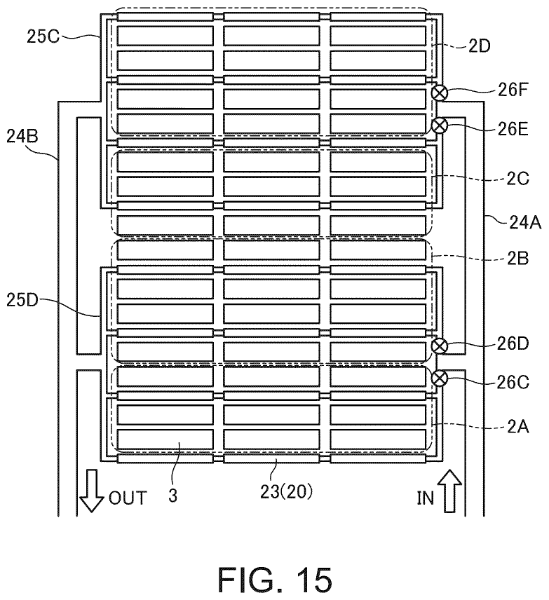

FIG. 15 is a schematic configuration diagram of another battery module including the battery temperature adjustment device. For example, a set of four battery modules may be provided as illustrated in FIG. 15. The total numbers of battery cells 3 and temperature adjustment plate 23 in battery modules 2A to 2D illustrated in FIG. 15 are equal to those of the mod(A) and the mod(B) illustrated in FIG. 3. On the other hand, in each of the battery modules 2A and 2C illustrated in FIG. 15, three rows and three columns, that is, nine battery cells 3 are disposed for one battery module. In addition, in each of the battery modules 2B and 2D illustrated in FIG. 15, four rows and three columns, that is, twelve battery cells 3 are disposed for one battery module.

When a channel switching valve 26C is opened and channel switching valves 26D, 26E, and 26F are closed, heating water can flow through two branch pipes 25D closer to an inflow port of heating water among four branch pipes 25D extending in the row direction, thereby warming up the battery module 2A. In addition, when the channel switching valve 26D is opened and the channel switching valves 26C, 26E, and 26F are closed, heating water can flow through two branch pipes 25D farther from the inflow port of heating water among the four branch pipes 25D extending in the row direction, thereby warming up the battery module 2B.

When the channel switching valve 26E is opened and the channel switching valves 26C, 26D, and 26F are closed, heating water can flow through two branch pipes 25C closer to the inflow port of heating water among four branch pipes 25C extending in the row direction, thereby warming up the battery module 2C. In addition, when the channel switching valve 26F is opened and the channel switching valves 26C, 26D, and 26E are closed, heating water can flow through two branch pipes 25C farther from the inflow port of heating water among the four branch pipes 25C extending in the row direction, thereby warming up the battery module 2D.

The above-described first charging control method, warm-up control method, second charging control method, and warm-up control method can be applied to a plurality of battery modules including the battery modules in the configuration illustrated in FIG. 15. In this case, a battery temperature sensor 11, a battery voltage sensor 12, a battery current sensor 13, and a DC-DC converter are provided for each battery module. The plurality of DC-DC converters are collectively referred to as a DC-DC converter 4. Note that, in a case where a battery module having a battery temperature equal to or higher than the above-described first temperature T1 exists, warm-up is performed preferentially from a battery module having the highest battery temperature among battery modules having battery temperatures lower than the first temperature T1.

### 8: Effects and Others

As described above, the charging control system 40 for secondary batteries according to the present embodiment includes at least the plurality of battery temperature sensors 11, the battery temperature adjustment device 20, the plurality of DC-DC converters (DC-DC converter 4), the BECM 10, and the PCM 14.

The charging control system 40 performs charging control including warm-up control for a plurality of battery modules (batteries) mounted on the vehicle 1. The plurality of battery modules are connected in parallel when used, and are simultaneously charged from the charging facility 30 as an external power source during charging.

One of the battery temperature sensors 11 and the DC-DC converter 4 are provided in each of the plurality of battery modules. The DC-DC converter 4 is configured to adjust the charging current in accordance with the SOC together with the battery temperature. More specifically, the DC-DC converter 4 is configured to perform adjustment to lower the value of charging current as the battery temperature is lower. In addition, the DC-DC converter 4 is configured to perform adjustment to lower the value of charging current as the SOC is higher. The BECM 10 and the PCM 14 control at least the battery temperature adjustment device 20 and the DC-DC converter 4. The BECM 10 also functions as an SOC determination unit in each of the plurality of battery modules. Specifically, the BECM 10 calculates the SOC based on the detection results of the battery voltage sensor 12 and the battery current sensor 13 in each of the plurality of battery modules, and further, determines the magnitude relationship with a predetermined reference, for example, 95%.

In a case where a plurality of battery modules having temperatures lower than the first temperature T1 exist among the plurality of battery modules, the BECM 10 and the PCM 14 determine a warm-up order for the plurality of battery modules to maximize the charge amounts of the battery modules as a battery pack within the set charging time tᵤₛₑᵣ. In addition, the BECM 10 and the PCM 14 control the DC-DC converters 4 to perform charging simultaneously with start of initial warm-up and concurrently at maximum current values set based on the respective temperatures of the plurality of battery modules. The first temperature T1 is the warm-up completion temperature of each battery module and lower than the threshold temperature Tₕₑₐₜ for determining necessity of warm-up of the battery module.

In a case where a battery module having a battery temperature lower than the threshold temperature Tₕₑₐₜ set in advance exists, the BECM 10 and the PCM 14 determine the warm-up order in accordance with the battery temperature of each of the plurality of battery modules.

According to the present embodiment, with the same amount of heating, a greater total charge amount can be obtained than in a case where the plurality of battery modules are simultaneously warmed up.

In addition, in the configuration disclosed in JP2023-101151A, charging is performed sequentially from battery modules in which battery temperatures have been increased to a predetermined temperature or higher by warming up. However, in this method, a long time is needed to complete charging of the plurality of battery modules. On the other hand, according to the present embodiment, even when the battery temperatures of some battery modules are low, charging is performed at maximum current values that can be supplied, and thus a time taken for charging of the plurality of battery modules can be shortened.

The BECM 10 and the PCM 14 preferably control the battery temperature adjustment device 20 to perform warm-up preferentially from the battery module on the high temperature side to maximize the charge amounts of the battery modules as a battery pack within the set charging time tᵤₛₑᵣ. In this manner, with the same amount of heating, a greater total charge amount can be reliably obtained than in a case where the plurality of battery modules are simultaneously warmed up.

In addition, in a case where a battery module having a battery temperature equal to or higher than the first temperature T1 exists, the BECM 10 and the PCM 14 may control the battery temperature adjustment device 20 to perform warm-up preferentially from a battery module having the highest temperature among battery modules having battery temperatures lower than the first temperature T1.

In this case as well, with the same amount of heating, a greater total charge amount can be obtained than in a case where the plurality of battery modules are simultaneously warmed up. In addition, the effect (temperature adjustment effect) of shortening the charging time due to warm-up is small for the high-temperature-side battery module in a case where the battery temperature is equal to or higher than the first temperature T1. Thus, a total time taken for charging of the plurality of battery modules can be shortened when warm-up is started from the low-temperature-side battery module.

In addition, the BECM 10 performs charge amount prediction calculation based on at least the initial temperatures of the plurality of battery modules, the initial SOC, and a target charging time, and derives the warm-up order of the plurality of battery modules and the warm-up completion temperatures.

In addition, in charge amount prediction calculation, the BECM 10 and the PCM 14 vary the warm-up completion temperatures and calculate definitive charge amounts (final charge amounts) in a case where warm-up is performed from the high-temperature-side battery module and in a case where warm-up is performed from the low-temperature-side battery module, respectively. In addition, the BECM 10 and the PCM 14 derive the warm-up completion temperatures at which the derived final charge amounts are largest, respectively, compare the maximum values of the respective final charge amounts, and determine a warm-up order of battery modules that results in the largest final charge amount. Furthermore, the BECM 10 and the PCM 14 control the battery temperature adjustment device 20 to perform warm-up in accordance with the determined warm-up order.

In this manner, it is possible to appropriately and accurately set warm-up conditions for the plurality of battery modules for maximizing the charge amounts within the target charging time tᵤₛₑᵣ set by the user. In other words, the BECM 10 and the PCM 14 determine a warm-up order of the plurality of battery modules so that the maximum value of the charge amounts is obtained within the target charging time tᵤₛₑᵣ, and further, warm up the plurality of battery modules by changing the warm-up completion temperatures.

In addition, the BECM 10 and the PCM 14 preferentially warm up a battery module for which warm-up is started first until the temperature of the battery module reaches the warm-up completion temperature. For example, in a case where warm-up is performed from the high-temperature-side battery module, the mod(H) is warmed up to the warm-up completion temperature T_{end1} and then warm-up of the mod(H) is stopped, and warm-up of the mod(L) is started to warm up the mod(L) to the warm-up completion temperature T_{end1}. In this manner, a total time taken for warming up the battery modules can be shortened.

A secondary battery charging control method according to the present embodiment includes at least first to third steps described below.

At the first step, inputting of the initial battery temperature of each of the plurality of battery modules is received (steps S4 and S6 in FIG. 5, step S90 in FIG. 8, and FIG. 10).

At the second step, a warm-up order and warm-up completion temperatures of the plurality of battery modules are derived based on the initial battery temperature of each of the plurality of battery modules, which is received at the first step (steps S4 to S7 in FIG. 5, steps S92 and S93 in FIG. 8, and FIG. 10).

At the third step, the plurality of battery modules are individually warmed up based on the warm-up order and warm-up completion temperatures of the plurality of battery modules, which are derived at the second step, whereas the plurality of battery modules are simultaneously charged (step S8 and the following steps in FIG. 6A, step S31 and the following steps in FIG. 6C, step S95 and the following steps in FIG. 9A, and step S105 and the following steps in FIG. 9B). Note that, in the present application specification, individual warm-up of the plurality of battery modules includes determination of the warm-up order of the battery modules through the procedures illustrated in FIGS. 5 to 10 and warm-up of the plurality of battery modules in accordance with the determined warm-up order.

In this manner, with the same amount of heating, a greater total charge amount can be obtained than in a case where the plurality of battery modules are simultaneously warmed up. In addition, a total time taken for charging the plurality of battery modules can be shortened.

At the first step, inputting of the initial SOC of each of the plurality of battery modules and the target charging time tᵤₛₑᵣ is further received. In this case, at the second step, it is preferable to predict and calculate the charge amounts of the plurality of battery modules based on at least the parameters input at the first step, the heat capacities of the plurality of battery modules, and the charging current map, and to extract the warm-up completion temperature.

In this manner, it is possible to appropriately and accurately set warm-up conditions of the plurality of battery modules, thereby maximizing the charge amounts within the target charging time tᵤₛₑᵣ.

In a case where the initial battery temperature of each of the plurality of battery modules is equal to or higher than the predetermined threshold temperature Tₕₑₐₜ or warm-up is completed for each of the plurality of battery modules, warm-up of the plurality of battery modules is not performed at the third step. In this manner, unnecessary warm-up work and warm-up energy can be omitted.

In addition, a charging control program according to the present embodiment causes one or more CPUs provided in the BECM 10 and/or the PCM 14 to execute the above-described charging control method.

In this manner, charging control of the plurality of battery modules can be performed in a simple and reliable way. Note that the program is preferably stored in a storage unit (not illustrated) provided inside or outside the vehicle 1. In a case where the storage unit is provided outside the vehicle 1, the program is read by the BECM 10 and/or the PCM 14 through a communication unit not illustrated.

### Embodiment 2

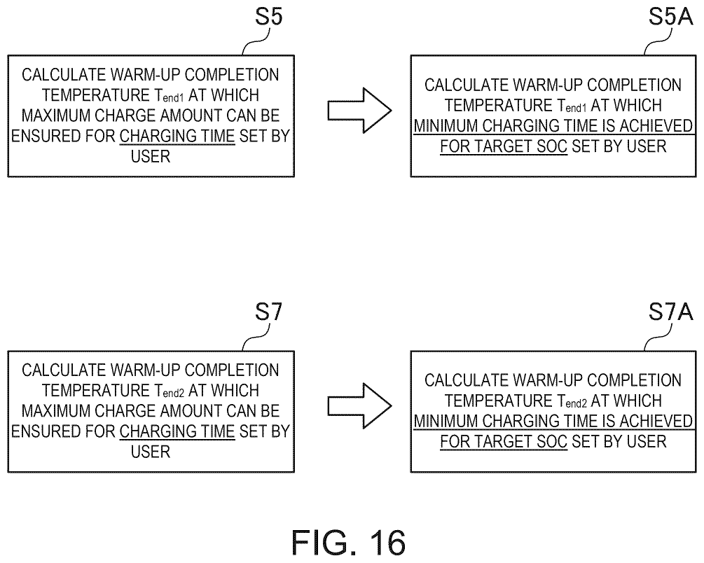

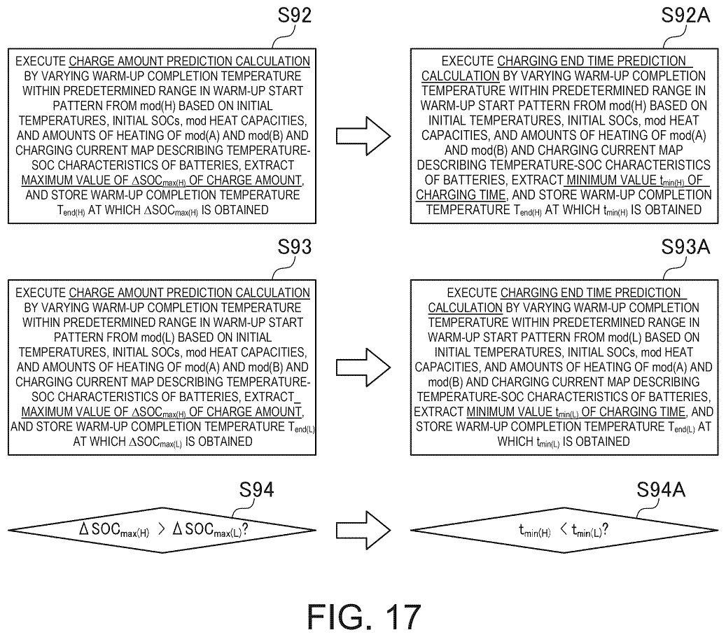

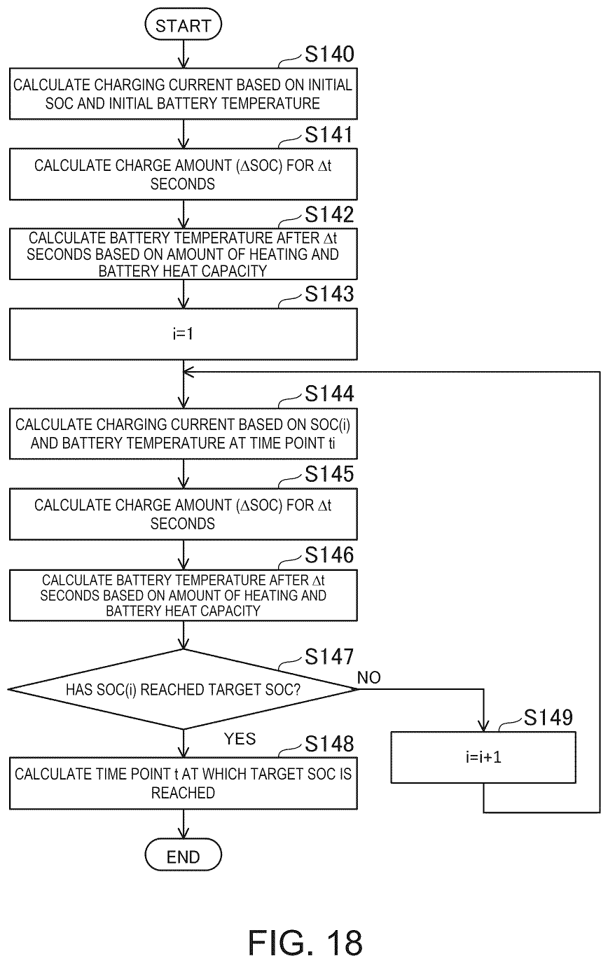

FIG. 16 is a diagram illustrating the difference between a battery charging control procedure according to Embodiment 2 and the battery charging control procedure according to Embodiment 1. FIG. 17 is a diagram illustrating the difference between a battery warm-up control procedure according to Embodiment 2 and the battery warm-up control procedure according to Embodiment 1. FIG. 18 is a flowchart illustrating a prediction calculation procedure for a charging time until a target SOC is reached.

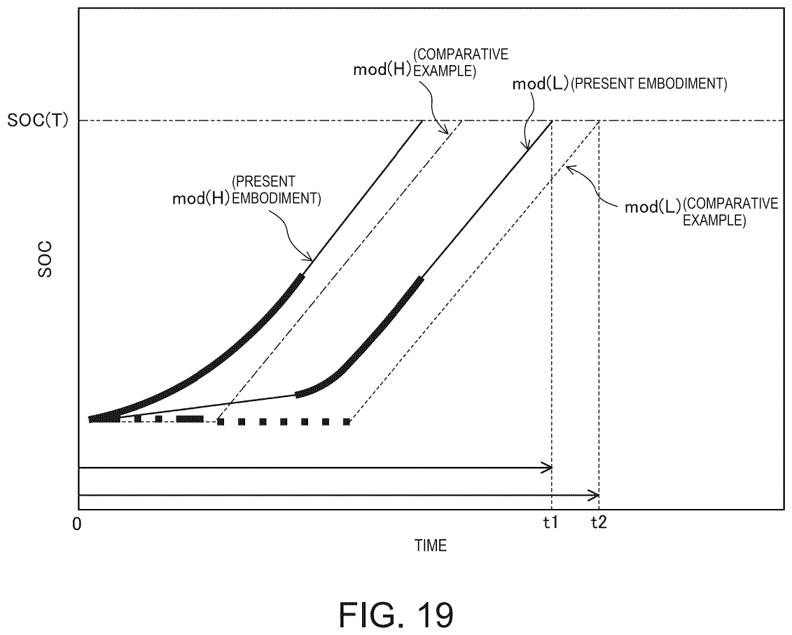

FIG. 19 is a diagram illustrating time-series change of the SOCs of battery modules A and B in a case where warm-up is performed from the high-temperature-side module. Note that each part illustrated with a bold line in a curve representing the SOC time-series change in FIG. 19 corresponds to a warm-up duration.

In addition, for convenience of description, in diagrams illustrated in FIG. 16 and the following figures, any same part as in Embodiment 1 is denoted by the same reference sign and detailed description thereof is omitted.

In Embodiment 1, an aspect is described in which as illustrated in FIGS. 5, 8, and 10, the user sets the target charging time tᵤₛₑᵣ in advance and a maximum total charge amount is obtained when a plurality of battery modules are charged within the target charging time tᵤₛₑᵣ.

On the other hand, in the present embodiment, the user may set in advance an SOC (target SOC) as a target in the setting condition (INPUT2) illustrated in FIG. 10. In this case, the charging time until the target SOC is reached can be minimized.

In this case, as illustrated in FIG. 16, steps S5 and S7 in FIG. 5 are changed to steps S5A and S7A, respectively. At step S5A, the warm-up completion temperature T_{end1} at which the charging time can be shortened for the target SOC set by the user is calculated. At step S7A, the warm-up completion temperature T_{end2} at which the charging time can be shortened for the target SOC set by the user is calculated.

In addition, as illustrated in FIG. 17, steps S92 to S94 in FIG. 8 are changed to steps S92A to S94A, respectively. At step S92A, the BECM 10 executes charging time prediction calculation based on the various parameters read at step S90 and the heat capacities of the mod(A) and the mod(B). This calculation is performed by varying the warm-up completion temperature within a predetermined temperature range in a pattern in which warm-up is started from the mod(H). In addition, a minimum charging time t_{min(H)} is extracted as an execution result of the prediction calculation. In addition, the warm-up completion temperature T_{end(H)} of the mod(H) when the charging time is minimum is extracted and stored in the above-described storage unit.

At step S93A, the BECM 10 executes charging time prediction calculation based on the various parameters read at step S90, the charging current map, and the heat capacities of the mod(A) and the mod(B). This calculation is performed by varying the warm-up completion temperature within a predetermined temperature range in a pattern in which warm-up is started from the mod(L). In addition, a minimum charging time t_{min(L)} is extracted as an execution result of the prediction calculation. In addition, the warm-up completion temperature T_{end(L)} of the mod(L) when the charging time is minimum is extracted and stored in the above-described storage unit.

At step S94A, it is determined whether t_{min(H)} is smaller than t_{min(L)} . The process proceeds to the subprocess G in a case where the determination result at step S94A is positive, or the process proceeds to the subprocess H in a case where the determination result is negative.

In addition, when the initial input condition and the charging setting condition are input, the BECM 10 calculates SOC time-series change in accordance with the process illustrated in FIG. 18 (process B illustrated in FIG. 10).

First, the charging current map, specifically, charging current is calculated based on the initial SOC and the initial battery temperature (step S140). Subsequently, the charge amount ΔSOC until Δt seconds elapse since the start of charging is calculated (step S141), and further, the battery temperature after Δt seconds from the start of charging is calculated based on the amount of heating and the battery heat capacity (step S142).

Subsequently, i=1 is set (step S143), and the charging current is calculated based on the SOC at the time point ti (hereinafter referred to as SOC(i)) and the battery temperature (step S144). Subsequently, the charge amount ΔSOC until Δt seconds elapse since the time point ti is calculated (step S145), and further, the battery temperature after Δt seconds from the time point ti is calculated based on the amount of heating and the battery heat capacity (step S146). Subsequently, it is determined whether the SOC at a time point (ti+Δt) has reached the target SOC (step S147). In a case where the determination result at step S147 is negative, that is, the SOC at the time point (ti+Δt) has not reached the target SOC, i=i+1 is set (step S149) and the process returns to step S144 and repeatedly executes the series of processes at steps S144 to S147 until the determination result at step S147 becomes positive.

In a case in which the determination result at step S147 is positive, the time point t at which the target SOC is reached is calculated (step S148), and SOC time-series change until the time point t is calculated.

Note that, similarly to the process A, the process B is executed for each combination of the warm-up order and the warm-up completion temperature. In addition, as an execution result, SOC time-series change until the target SOC is reached in a case where the warm-up completion temperature and the warm-up order are changed, that is, a group of SOC time charts are obtained.

As described above, the charging control system 40 for secondary batteries according to the present embodiment is different from the configuration described in Embodiment 1 in the following points.

The BECM 10 performs charging time prediction calculation based on at least the initial temperatures, initial SOCs, and target SOCs of the plurality of battery modules and derives the warm-up order and warm-up completion temperatures of the plurality of battery modules.

In addition, in charging time prediction calculation, the BECM 10 and the PCM 14 vary the warm-up completion temperatures and calculate definitive charging times (charging required times) in a case where warm-up is performed from the high-temperature-side battery module and in a case where warm-up is performed from the low-temperature-side battery module, respectively. In addition, the BECM 10 and the PCM 14 derive the warm-up completion temperatures at which the derived charging required times are shortest, respectively, compare the minimum values of the respective charging required times, and determine a warm-up order of battery modules that results in the shortest charging required time. In addition, the BECM 10 and the PCM 14 control the battery temperature adjustment device 20 to perform warm-up in accordance with the determined warm-up order.

In this manner, it is possible to appropriately and accurately set warm-up conditions of the plurality of battery modules for minimizing the charging time for the target SOC set by the user. In other words, the BECM 10 and the PCM 14 determine a warm-up order of the plurality of battery modules so that the minimum value of the charging time for the target SOC is obtained, and further, warm up the plurality of battery modules by changing the warm-up completion temperatures.

In addition, according to the present embodiment, in a battery pack constituted by a plurality of battery modules, charging work for obtaining the same charge amount can be completed in a shorter charging time. For example, in the comparative example in FIG. 18, warm-up is performed in the order of the mod(H)→the mod(L) and charging is started after the battery temperature after warm-up becomes equal to or higher than a predetermined temperature. This is the same method as that disclosed in JP2023-101151A. In this case, t2 represents a time from when warm-up and charging of the mod(H) starts until afterwards when the mod(L) warming up reaches SOC(T) as the target SOC. The time t2 is the total charging time of the mod(H) and the mod(L) in the comparative example.

On the other hand, according to the present embodiment, as described in Embodiment 1, warm-up is performed in the order of the mod(H)→the mod(L) and charging of the mod(H) is started together with start of warm-up and charging of the mod(H). With this, the total charging time t2 until the mod(H) and the mod(L) reach the SOC(T) in the present embodiment can be made shorter than the above-described time t1.

A secondary battery charging control method according to the present embodiment is different from the charging control method described in Embodiment 1 in the following points.

At the first step, inputting of the initial SOC and target SOC of each of the plurality of battery modules is further received. In this case, at the second step, it is preferable to predict and calculate the charging times of the plurality of battery modules based on at least the parameters input at the first step, the heat capacity of each of the plurality of battery modules, and the charging current map, and to extract the warm-up completion temperatures.

In this manner, it is possible to appropriately and accurately set warm-up conditions of the plurality of battery modules and to minimize the charging time for the target SOC.

In addition, as described in Embodiment 1, a charging control program according to the present embodiment causes one or more CPUs provided in the BECM 10 and/or the PCM 14 to execute the charging control method described in the present embodiment. In this manner, charging control of the plurality of battery modules can be performed in a simple and reliable way.

### Other Embodiments

The target charging time tᵤₛₑᵣ and the target SOC can be said to be charging-related requirements for a plurality of battery modules as a battery pack. Thus, in a case where a battery module having a temperature lower than the first temperature T1 exists among the plurality of battery modules, the BECM 10 and the PCM 14 disclosed in the present application specification perform control described below. First, under a predetermined setting condition, in a case where a plurality of battery modules having temperatures lower than the first temperature T1 that is a warm-up completion temperature exist among the plurality of battery modules, a warm-up order is determined for the plurality of battery modules to maximize a charging-related requirement as the battery pack under a predetermined setting condition. In addition, the DC-DC converters 4 are controlled so that charging is performed simultaneously with start of initial warm-up and concurrently at maximum current values set based on the respective temperatures of the plurality of battery modules. Note that the first temperature T1 is lower than the threshold temperature Tₕₑₐₜ for determining necessity of warm-up.

In this manner, the charging-related requirement for the plurality of battery modules can be maximized in accordance with setting by the user irrespective of the respective battery temperatures of the plurality of battery modules. In addition, the warm-up order of battery modules can be easily determined by setting the first temperature T1 to be lower than the threshold temperature Tₕₑₐₜ.

In a case where the setting condition is a target charging time (=tᵤₛₑᵣ) and the charging-related requirement is maximization of the charge amount of the battery pack, the BECM 10 and the PCM 14 control the battery temperature adjustment device 20 to perform warm-up preferentially from the high-temperature-side battery module.

Note that, in a case where a battery module having a battery temperature equal to or higher than the first temperature T1 exists, the BECM 10 and the PCM 14 may control the battery temperature adjustment device 20 to perform warm-up preferentially from the battery module having the highest temperature among the battery modules having battery temperatures lower than the first temperature T1.

In addition, when the target charging time tᵤₛₑᵣ is set, the BECM 10 and the PCM 14 change the warm-up completion temperatures of the plurality of battery modules to maximize the charge amount as the battery pack.

In this manner, with the same amount of heating, a greater total charge amount can be obtained than in a case where the plurality of battery modules are simultaneously warmed up.

In addition, in a case where the setting condition is the target SOC and the charging-related requirement is minimization of the charging time of the battery pack until the target SOC is reached, the BECM 10 and the PCM 14 control the battery temperature adjustment device 20 to perform warm-up preferentially from the high-temperature-side battery module.

Note that, in a case where a battery module having a battery temperature equal to or higher than the first temperature T1 exists, the BECM 10 and the PCM 14 may control the battery temperature adjustment device 20 to perform warm-up preferentially from the battery module having the highest temperature among the battery modules having battery temperatures lower than the first temperature T1.

In addition, when the target SOC is set, the BECM 10 and the PCM 14 change the warm-up completion temperatures of the plurality of battery modules to minimize the charging time of the battery pack.

In this manner, with the same amount of heating, the plurality of battery modules can be charged in a shorter charging time than in a case where the plurality of battery modules are simultaneously warmed up.

In addition, the BECM 10 disclosed in the present application specification can be said to perform prediction calculation of a numerical value associated with the charging-related requirement for the plurality of battery modules, that is, a required value, based on a plurality of parameters related to the plurality of battery modules and to derive the warm-up order and warm-up completion temperatures of the plurality of battery modules.

More specifically, in prediction calculation of the required value, the BECM 10 varies the warm-up completion temperatures and calculates charging-related required values in a case where warm-up is performed from the high-temperature-side battery module and in a case where warm-up is performed from the low-temperature-side battery module, respectively. In addition, the BECM 10 derives the warm-up completion temperatures corresponding to the derived required values in the respective cases. The BECM 10 and the PCM 14 compare the respective derived required values and determine the warm-up order of battery modules to have the maximum or minimum required value. In addition, the BECM 10 and the PCM 14 control the battery temperature adjustment device 20 to perform warm-up in accordance with the determined warm-up order.

In a case where the target charging time tᵤₛₑᵣ is set and the charging-related requirement is maximization of the charge amount, the BECM 10 and the PCM 14 compare respective derived final charge amounts and determine the warm-up order of battery modules to have the maximum or minimum final charge amount. In addition, the BECM 10 and the PCM 14 control the battery temperature adjustment device 20 to perform warm-up in accordance with the determined warm-up order.

In addition, the BECM 10 and the PCM 14 control the battery temperature adjustment device 20 to perform warm-up from the battery module side on a temperature side with the larger final charge amount.

In addition, in a case where the target SOC is set and the charging-related requirement is minimization of the charging time until the target SOC is reached, the BECM 10 and the PCM 14 compare respective derived charging required times and determine the warm-up order of battery modules to have the minimum charging required time. In addition, the BECM 10 and the PCM 14 control the battery temperature adjustment device 20 to perform warm-up in accordance with the determined warm-up order.

In addition, the BECM 10 and the PCM 14 control the battery temperature adjustment device 20 to perform warm-up from the battery module side on a temperature side with the shorter charging required time.

In other words, the BECM 10 and the PCM 14 determine a warm-up order of the plurality of battery modules to maximize the charging-related requirement of the battery pack, and further, warm up the plurality of battery modules by changing the warm-up completion temperatures.

In this manner, it is possible to appropriately and accurately set warm-up conditions of the plurality of battery modules for maximizing the charging-related requirement for the battery pack set by the user.

In addition, a secondary battery charging control method disclosed in the present application specification includes at least first to third steps described below by using the charging control system 40.

At the first step, inputting of a plurality of parameters related to the plurality of battery modules is received.

At the second step, the warm-up order and warm-up completion temperatures of the plurality of battery modules are derived based on the respective parameters of the plurality of battery modules, which are received at the first step.

At the third step, the plurality of battery modules are individually warmed up based on the warm-up order and warm-up completion temperatures of the plurality of battery modules, which are derived at the second step, while the plurality of battery modules are simultaneously charged.

The plurality of parameters at the first step include the initial temperatures, initial SOCs, amounts of heating, and heat capacities of the plurality of battery modules, respectively, the charging current map, and a setting condition set by the user.

In this manner, when a plurality of secondary batteries are charged in parallel, the charging-related requirement for the battery pack can be maximized in accordance with settings at the time of charging irrespective of the temperatures of the respective batteries.

In a case in which the setting condition is the target charging time tᵤₛₑᵣ and the charging-related requirement is maximization of the final charge amount, the warm-up completion temperatures are varied at the second step to calculate final charge amounts in a case where warm-up is performed from the high-temperature-side battery module and in a case where warm-up is performed from the low-temperature-side battery module, respectively, and to compare the final charge amounts. In addition, at the third step, warm-up is performed from the battery module side on a temperature side with the larger final charge amount. Alternatively, at the third step, the plurality of battery modules are individually warmed up in accordance with a warm-up order determined to have the maximum final charge amount based on comparison of the final charge amounts, while the plurality of battery modules are simultaneously charged.

In this manner, with the same amount of heating, a greater total charge amount can be obtained than in a case where the plurality of battery modules are simultaneously warmed up.

In addition, in a case where the setting condition is the target SOC and the charging-related requirement is minimization of the charging required time, the warm-up completion temperatures are varied at the second step to calculate charging required times in a case where warm-up is performed from the high-temperature-side battery module and in a case where warm-up is performed from the low-temperature-side battery module, respectively, and to compare the charging required times. In addition, at the third step, warm-up is performed from the battery module side on a temperature side with the shorter charging required time. Alternatively, at the third step, the plurality of battery modules are individually warmed up in accordance with a warm-up order determined to have the minimum charging required time based on comparison of the charging required times, while the plurality of battery modules are simultaneously charged.

In this manner, with the same amount of heating, a total time taken for charging the plurality of battery modules can be made shorter than in a case where the plurality of battery modules are simultaneously warmed up.

In a case where the initial battery temperature of each of the plurality of battery modules is equal to or higher than the threshold temperature Tₕₑₐₜ for determining necessity of warm-up of the battery module or warm-up is completed for each of the plurality of battery modules, warm-up of the plurality of battery modules is not performed at the third step. In this manner, unnecessary warm-up work can be omitted.

In addition, a charging control program disclosed in the present application specification causes one or more CPUs provided in the BECM 10 and/or the PCM 14 to execute the above-described charging control method.

Note that the temperature increase rate of a battery module is higher as the amount of heating is larger. On the other hand, the temperature increase rate is substantially constant irrespective of battery temperature zones of the battery module. Accordingly, in a case where the battery temperatures of the plurality of battery modules are different from one another, the temperature increase rate is hardly different among them while their initial battery temperatures are different.

In addition, as the amount of heating, in other words, the temperature increase rate is smaller, maximization of the charging-related requirement of the battery pack with the same amount of heating can be further satisfied than in a case where the plurality of battery modules are simultaneously warmed up. However, even when the amount of heating is large, the charging speed is higher than in a case where the plurality of battery modules are simultaneously warmed up, and thus the effects of the present disclosure can be achieved.

### INDUSTRIAL APPLICABILITY

A charging control system for secondary batteries of the present disclosure is capable of efficiently warming up and charging an entire battery pack constituted by a plurality of secondary batteries, in accordance with settings at the time of charging, when charging the battery pack, and thus is useful.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1 vehicle
2A to 2B battery module (battery)
3 battery cell
4, 4A, 4B DC-DC converter
5 inverter
6 motor
7A, 7B circuit switching switch
10 BECM (control device)
11 battery temperature sensor
12 battery voltage sensor
13 battery current sensor
14 PCM (control device)
20 battery temperature adjustment device
21 heater
22 fluid pump
23 temperature adjustment plate
24A first main pipe
24B second main pipe
25A to 25D branch pipe
26A to 26D channel switching valve
30 charging facility
31 fast charger
40 charging control system

What is claimed is:

1. A charging control system for a plurality of secondary batteries constituting a battery pack, wherein
the plurality of secondary batteries included in the battery pack are connected in parallel during traveling,
the charging control system comprises:
a plurality of battery temperature sensors that are respectively provided for each of the plurality of secondary batteries and detect a temperature of the respective secondary battery;
a battery temperature adjustment device configured to switch which of the plurality of secondary batteries is to be warmed up;
a plurality of DC-DC converters respectively provided for each of the plurality of secondary batteries and configured to adjust a charging current to be lower as the temperature of the respective secondary battery is lower, and
at least one control device that controls each of the battery temperature adjustment device and the DC-DC converters, and
in a case where a plurality of the secondary batteries having temperatures lower than a first temperature as a warm-up completion temperature exist among the plurality of secondary batteries, the at least one control device determines a warm-up order for the plurality of secondary batteries to maximize a charging-related requirement as the battery pack under a predetermined setting condition and controls the DC-DC converters so that charging is performed simultaneously with start of initial warm-up and concurrently at maximum current values set based on respective temperatures.

2. The charging control system according to claim 1, wherein
the charging control system further comprises a state of charge (SOC) determination unit that determines an SOC in each of the plurality of secondary batteries, and
the DC-DC converters are configured to adjust the charging current in accordance with the SOC together with the temperature and configured to adjust the charging current to be lower as the SOC of the secondary battery is higher.

3. The charging control system according to claim 1, wherein in a case where the setting condition is a target charging time and the charging-related requirement is maximization of a charge amount of the battery pack, the at least one control device controls the battery temperature adjustment device to perform warm-up preferentially from a secondary battery of the plurality of secondary batteries on a high temperature side.

4. The charging control system according to claim 3, wherein in a case where the secondary battery having a temperature equal to or higher than the first temperature exists, the at least one control device controls the battery temperature adjustment device to perform warm-up preferentially from the secondary battery having the highest temperature among the secondary batteries having temperatures lower than the first temperature.

5. The charging control system according to claim 1, wherein in a case where the setting condition is a target charging time and the charging-related requirement is maximization of a charge amount of the battery pack, the at least one control device changes the warm-up completion temperature of the plurality of secondary batteries to maximize the charge amount as the battery pack at the target charging time.

6. The charging control system according to claim 1, wherein in a case where the setting condition is a target state of charge (SOC) and the charging-related requirement is minimization of a charging time of the battery pack until the target SOC is reached, the at least one control device controls the battery temperature adjustment device to perform warm-up preferentially from a secondary battery of the plurality of secondary batteries on a high temperature side.

7. The charging control system according to claim 6, wherein in a case where a secondary battery having a temperature equal to or higher than the first temperature exists, the at least one control device controls the battery temperature adjustment device to perform warm-up preferentially from a secondary battery having the highest temperature among the secondary batteries having temperatures lower than the first temperature.

8. The charging control system according to claim 1, wherein in a case where the setting condition is a target state of charge (SOC) and the charging-related requirement is minimization of a charging time of the battery pack until the target SOC is reached, the at least one control device changes the warm-up completion temperature of the secondary batteries to minimize the charging time of the battery pack.

9. The charging control system according to claim 1, wherein the at least control device performs prediction calculation of a value related to the requirement based on a plurality of parameters related to the plurality of secondary batteries and derives a warm-up order and warm-up completion temperatures of the plurality of secondary batteries.

10. The charging control system according to claim 9, wherein
the plurality of parameters include at least initial temperatures, initial state of charges (SOCs), amounts of heating, and target charging times of the plurality of secondary batteries, and
the at least one control device is further configured to:
vary the warm-up completion temperature of the secondary batteries, calculate final charge amounts in a case where warm-up is performed from a secondary battery of the secondary batteries on a high temperature side and in a case where warm-up is performed from a secondary battery of the secondary batteries on a low temperature side, respectively, and compare the final charge amounts, and
determine a warm-up order of the secondary batteries that results in the largest final charge amount and controls the battery temperature adjustment device to perform warm-up in accordance with the warm-up order.

11. The charging control system according to claim 9, wherein
the plurality of parameters include at least initial temperatures, initial state of charges (SOCs), amounts of heating, and target SOCs of the plurality of secondary batteries, and
the at least one control device is further configured to:
vary the warm-up completion temperature of the secondary batteries, calculate charging required times in a case where warm-up is performed from a secondary battery of the secondary batteries on a high temperature side and in a case where warm-up is performed from a secondary battery of the secondary batteries on a low temperature side, respectively, and compare the charging required times, and
determine a warm-up order of the secondary batteries that results in the shortest charging required time and controls the battery temperature adjustment device to perform warm-up in accordance with the warm-up order.
